(19) United States
(12) Patent Application Publication
(10) Pub. No.: US 2011/0086683 A1
(43) Pub. Date: Apr. 14, 2011

(54) SLIDING ASSEMBLY FOR PORTABLE HANDSET

(75) Inventor: Tony N. Kfoury, Lisle, IL (US)

(73) Assignee: AMPHENOL - T&M ANTENNAS, Vernon Hills, IL (US)

(21) Appl. No.: 12/756,664

(22) Filed: Apr. 8, 2010

Related U.S. Application Data
(63) Continuation of application No. 11/334,174, filed on Jan. 18, 2006, now abandoned.
(60) Provisional application No. 60/687,361, filed on Jun. 3, 2005.
(60) Provisional application No. 60/655,619, filed on Feb. 23, 2005.
(60) Provisional application No. 60/645,084, filed on Jan. 18, 2005.

(51) Int. Cl. H04M 1/00

(52) U.S. Cl. 455/575.4

(57) ABSTRACT

A self-contained sliding assembly for use with a sliding handset of the type having a keyboard part and a display part that are configured to slidably engage one another into fully open and fully closed positions, where the sliding assembly includes at least one elongated guide rail, a housing configured to engage the at least one guide rail and to move slidably along a length thereof, and a biasing assembly for biasing relative sliding movement of the guide rail and the housing, where the biasing assembly is configured to include open and closed stop positions and a maximum load position at a predetermined point between the open and closed stop positions.

### PRIORITY CLAIM AND APPLICATION REFERENCE

This application is a continuation of application Ser. No. 11/334,174, filed Jan. 18, 2006. Under 35 U.S.C. §119, this application claims the benefit under of prior provisional applications Ser. No. 60/645,084, filed Jan. 18, 2005; 60/655,619, filed Feb. 23, 2005; and 60/687,361, filed Jun. 3, 2005.

### TECHNICAL FIELD

A field of the invention is handheld devices, e.g., personal digital assistants and handsets. The invention particularly concerns handheld devices having two parts that move relative to one another.

### BACKGROUND OF THE INVENTION

Portable handsets such as cell phones and PDA's are a popular form of wireless mobile communication devices. While the configuration of these portable handsets may vary widely, cost, simplicity, ease of assembly and small size are omnipresent concerns in the design and manufacture of small portable flip devices. Further, advancements in the field of portable handsets have resulted in incorporation of additional electronics and technology in handsets, requiring further cost and size optimization for other components.

In a traditional flip style device, a flip part (such as a display part) and a main part (such as a keyboard part) are usually connected at a hinge axis that is generally in the plane of one or both of the flip part and the main part (or in a plane parallel to one of the flip part and the main part). This creates a clamshell style open and close feature. The flip-style arrangement is widely popular because it is conveniently sized and shaped, permitting storage of a phone in a small space, e.g. a pocket or a belt holder. Additionally, flip-style devices have proven to be aesthetically pleasing to a large segment of the target demographic of the consumer market. When closed, the flip style devices provide a small device footprint, making the storage of the device in a pocket, on a clip, in a holder, in a briefcase, in a purse, or a drawer, etc., very convenient.

However, the flip style opening can sometimes be awkward, for example it may be difficult for a user to open a flip-style devices with a single hand. Push-button or self-open flip hinges may address such issues. However, it is also important that the ease, reliability and simplicity of opening and closing not be compromised.

Further, hinges and hinge assemblies used to form a hinged connection in a handheld device, such as the flip style device, must withstand usage in a very demanding environment. Operational cycles are high frequency, meaning that users of flip style and other hinged handheld devices open and close the device frequently. In the example of a flip phone, a user commonly opens and closes the device with each use of the device. The hinge in a flip style device must also provide a smooth and controlled operation, and should be biased to remain in respective open and closed positions. There is considerable interest, however, in keeping the hinge simple and as inexpensive as possible. The handheld device market is extremely competitive, and component expenses must be kept as low as possible.

### SUMMARY OF THE INVENTION

An embodiment of the invention includes a self-contained sliding assembly for use with a sliding handset of the type having a keyboard part and a display part that are configured to slidably engage one another into fully open and fully closed positions. The sliding assembly includes at least one elongated guide rail and a housing configured to engage the at least one guide rail and to move slidably along a length thereof. The sliding assembly also includes a biasing assembly for biasing relative sliding movement of the guide rail and the housing, where the biasing assembly is configured to include open and closed stop positions and a maximum load position at a predetermined point between the open and closed stop positions.

### DESCRIPTION OF THE DRAWINGS

FIG. 1 is a front elevational view of an exemplary handset that may be used in combination with one or more embodiments of the instant invention;

FIG. 2 is an exploded view of the sliding assembly according to a first embodiment of the invention;

FIG. 3 is a top perspective view of a housing of FIG. 2;

FIG. 4 is a cross-section of an assembled version of the sliding assembly illustrated in FIG. 2;

FIG. 5 is a front elevational view of the sliding assembly of FIG. 2;

FIG. 6 is a front perspective view of an exemplary handset in the closed position with the sliding assembly of FIG. 2 coupled thereto;

FIG. 7 is a front perspective view of the exemplary handset of FIG. 6 in the open position;

FIG. 8 is an exploded view of the exemplary handset of FIG. 6 and the sliding assembly of FIG. 2;

FIG. 9 is an exploded view of the sliding assembly according to a second preferred embodiment of the invention;

FIG. 10 is a cross-section of an assembled version of the sliding assembly illustrated in FIG. 9;

FIG. 11 is an exploded view of a sliding assembly according to a third preferred embodiment of the invention;

FIG. 12 is a front perspective view of the sliding assembly illustrated in FIG. 11;

FIG. 13 is a front elevational view of the sliding assembly illustrated in FIG. 11;

FIG. 14 is an exploded view of an exemplary handset and the sliding assembly illustrated in FIG. 11;

FIG. 15 is a front perspective view of the sliding assembly illustrated in FIG. 11 in the fully open position;

FIG. 16 is a front perspective view of the sliding assembly illustrated in FIG. 11 at the mid-point position;

FIG. 17 is a front perspective view of a sliding assembly according to a fourth preferred embodiment of the invention;

FIG. 18 is an exploded perspective view of the sliding assembly of FIG. 17;

FIG. 19 is an exploded view of a sliding assembly according to a fifth preferred embodiment;

FIG. 20 is a front perspective view of the biasing assembly of the sliding assembly illustrated in FIG. 19;

FIG. 21 is a top perspective view of the sliding assembly illustrated in FIG. 19 in the fully closed position;

FIG. 22 is a top perspective view of the sliding assembly illustrated in FIG. 19 in the mid-point position;

FIG. 23 is a top perspective view of the sliding assembly illustrated in FIG. 19 in the fully open position;

FIG. 24 is a top perspective view of a sliding assembly according to a sixth preferred embodiment of the invention;

FIG. 25 is a bottom perspective view of the sliding assembly illustrated in FIG. 24;

FIG. 26 is an exploded view of the sliding assembly illustrated in FIG. 24;

FIG. 27 is an exploded view of the sliding assembly illustrated in FIG. 24 and an exemplary handset;

FIG. 28 is a top perspective view of the biasing assembly of the sliding assembly illustrated in FIG. 24;

FIG. 29 is a top perspective view of the sliding assembly illustrated in FIG. 24 in the fully closed position;

FIG. 30 is a top perspective view of the sliding assembly illustrated in FIG. 24 in the mid-point position;

FIG. 31 is a top perspective view of the sliding assembly illustrated in FIG. 24 in the fully open position;

FIG. 32 is a top perspective view of a sliding assembly according to a seventh preferred embodiment of the invention;

FIG. 33 is a top perspective view of the sliding assembly illustrated in FIG. 32 in the mid-point position;

FIG. 34 is a top perspective view of the sliding assembly illustrated in FIG. 32 in the fully open position;

FIG. 35 is a top perspective view of a sliding assembly according to an eighth preferred embodiment; and

FIG. 36 is a top perspective view of the sliding assembly of FIG. 35 shown in the fully open position.

### DETAILED DESCRIPTION OF THE INVENTION

Flip style handheld devices, such as flip style handsets and PDAs, open and close via a flipping mechanism, where a main part and a flip part are coupled via a hinged connection and rotate with respect to one another via the hinged connection. More particularly, the flip part (such as a display part) and the main part (such as a keyboard part) are usually connected at a hinge axis that is generally in the plane of one or both of the flip part and the main part (or in a plane parallel to one of the flip part and the main part). This creates a clamshell style open and close feature.

In contrast, embodiments of the instant invention provide a self-contained sliding assembly for a handset, such that a first part, typically a display part, and a second part, typically a keyboard part, are slidably coupled to one another in a manner that permits smooth and reliable parallel sliding movements of the main and flip parts relative to one another into the fully open and fully closed positions. This provides a user with pleasing and unique operation of the handset, which is also robust, stylish and that retains the compact size and other desirable features of typical clamshell style handset openings. Advantageously, the various embodiments of the instant sliding assembly are self-contained such that while the sliding assembly is coupled to a handset in one of multiple ways, the handset need not provide features to promote sliding.

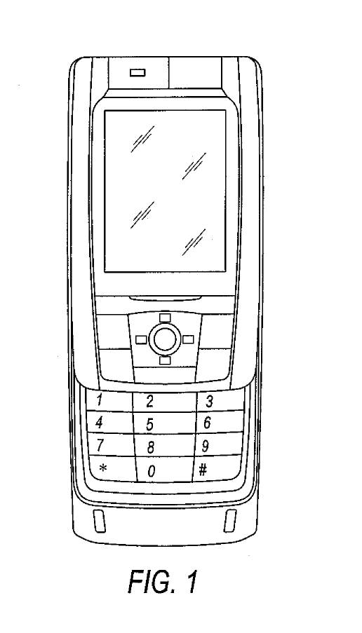

While it is contemplated that embodiments of the sliding assembly provided by the invention may be used with a variety of handsets amenable to slidable coupling, and that dimensions may vary to suit individual applications, embodiments of the invention will be illustrated and discussed in connection with the exemplary handset illustrated in FIG. 1 and designated generally at 10.

Handsets of this type typically include a first part, such as a display part, generally at 12, that includes among other things, a display such as an LCD display, and second part, such as a keyboard part, generally at 14, that includes among other things, a keyboard. The display part 12 and the keyboard part 14 in preferred devices of the invention are slidably coupled to one another via various embodiments of the inventive sliding assembly in a manner the permits smooth and reliable sliding into the respective open and closed positions. Advantageously, the sliding assembly in preferred embodiments is minimized and optimized for size and containment, with the working parts of the sliding assembly contained within a housing, concealing the working parts from loss, contamination, or jarring loose within the handset.

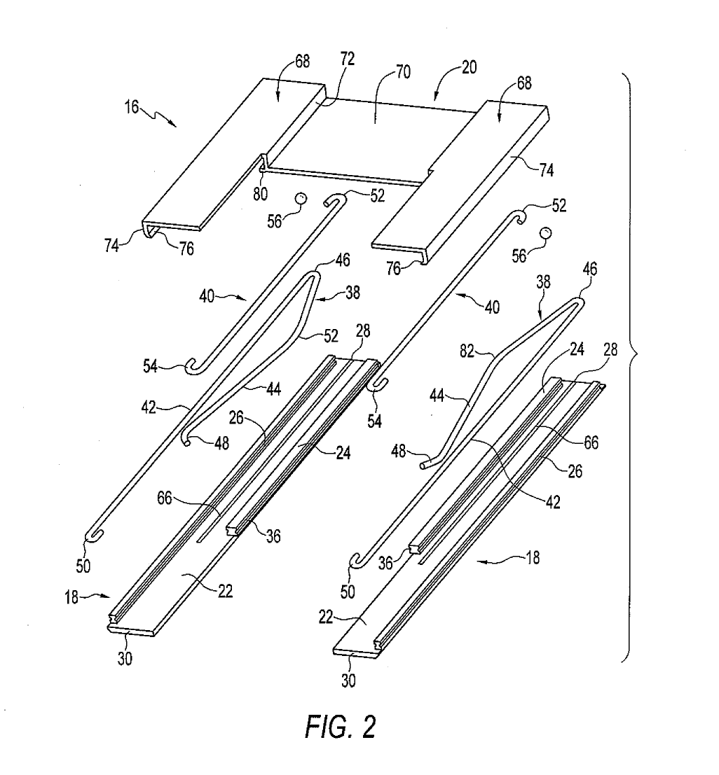

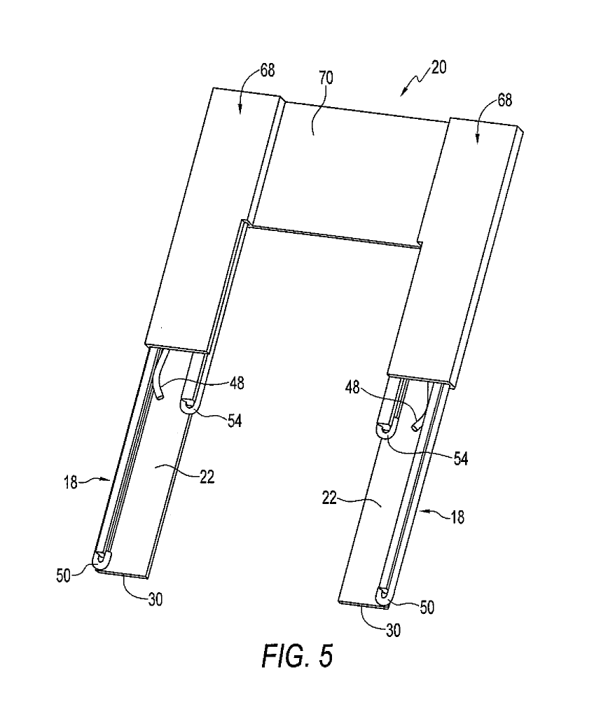

Turning now to FIGS. 2 through 8, a first preferred embodiment of the sliding assembly is illustrated in connection with the handset 10, and is designated generally at 16. As illustrated in FIG. 2, at least one and preferably two guide rails, designated generally at 18, are provided, and a correspondingly sized and configured housing, designated generally at 20, is also provided to slidably engage the guide rails. Once engaged, the housing 20 and the guide rails 18 are disposed within or attached to separate parts of a handset 10 in a predetermined configuration such that relative sliding of the display part 12 and a keyboard part 14 are possible.

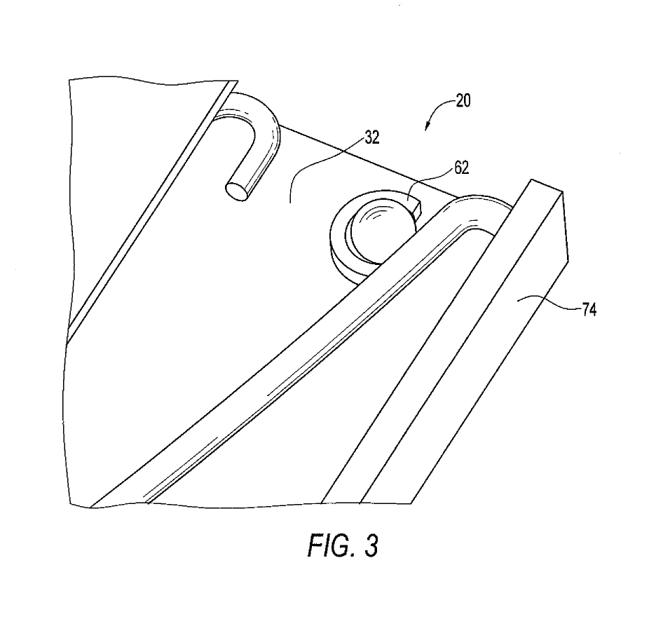

More particularly, each of the guide rails 18 is generally rectangular in shape with a generally planar receiving surface 22 and inner and outer side walls 24, 26 disposed along at least a portion of the side edges of the receiving surface. Top and bottom edges 28, 30 of the receiving surface 22 are preferably open. In turn, as illustrated in FIG. 3, an underside 32 of the housing 20 is configured to slidably and matingly engage the guide rails 18 to enclose a plurality of features disposed between the housing and the guide rails, wherein these features promote the sliding of the housing and the guide rails with respect to one another. While in the illustrated embodiments the guide rails 18 are disposed in the display part 12 and the housing 20 is disposed in the keyboard part 14, it is contemplated that the relative positioning of the guide rails and the housing may be reversed. As a result of the positioning of the housing 20 and the guide rails 18 within the respective keyboard and display parts 14, 12, and the engagement of the housing and the guide rails, the handset 10 in which the sliding assembly 16 is disposed is capable of sliding into either the open or closed positions.

Turning first to the guide rails 18 as illustrated in FIGS. 2-5, it will first be appreciated that where two guide rails are provided, they are typically oriented to be mirror images with respect to one another. The outer side wall 26 of the guide rails 18 extends along substantially an entire length of the guide rail, from the top edge 28 to a point just above the bottom edge 30. The inner side wall 24 is preferably shorter than the outer side wall 26, extending generally halfway or slightly longer than halfway along the length of the guide rail 18. The inner side walls 24 preferably includes a shelf 34 having an elongated groove 36 disposed along a length thereof.

An elongated spring, designated generally at 38, is accordingly sized and configured to engage the outer side wall 26, while an elongated slide rail, designated generally at 40, is sized and configured to engage the inner side wall 24. While it is contemplated that both the spring 38 and the slide rail 40 may assume a plurality of configurations without departing from their respective functions, one particular configuration is described herein for exemplary purposes.

The spring 38, as illustrated in FIG. 2, has a generally linear backbone 42 and a convex bowed portion 44. The backbone 42 is configured to have a hairpin curve 46 at a top end that extends outwardly into the convex bowed portion 44, which is unitary with the backbone. An end of the convex bowed portion 44 opposite the hairpin curve 46 also includes an arcuate hook 48. At a bottom end, the backbone includes a U-shaped portion 50. Thus, both the top and bottom ends of the backbone 42 are curved such that the linear backbone extends along an outside surface of the outer side wall 26, with the hairpin curve 46 wrapped around the top end of the outer side wall, and the U-shaped portion 50 wrapped around the bottom end of the outer side wall. The linear backbone 42 is accordingly preferably sized and configured to correspond to the length and width of the outer side wall 26, and is coupled to the outer side wall via a snap-fit or frictional engagement, with the convex bowed portion 44 extending toward a middle of the respective guide rail 18. The spring 38, including the linear backbone 42, is preferably made from a high polish wire having a very low coefficient of friction such that when the housing is coupled the guide rails 18, the backbone promotes smooth sliding movement of the housing 20 with respect to the guide rails.

As also illustrated in FIG. 2, the slide rail 40 is sized and configured to correspond to the length and width of the inner side wall 24, and includes U-shaped portions 52, 54 at both a top and a bottom end thereof such that the respective slide rail 18 engages an outside surface of the inner side wall in a snap-fit or frictional engagement. When coupled to the guide rail 18, the U-shaped portions 52, 54 are oriented to extend toward the middle of the guide rail. Like the spring 38, the slide rail 40 is preferably made from a high polish wire having a very low coefficient of friction such that when the housing 20 is coupled the guide rails 18, the spring promotes smooth sliding movement of the housing with respect to the guide rails.

A sliding element is also provided between the guide rails 18 and the housing 20, which is configured to move along the receiving surface 22 of each respective guide rail as the housing moves relative to the guide rail. In the first preferred sliding assembly 10, the sliding element is a ball bearing 56 that rotates within the underside 32 of the housing 20 as the guide rails 18 moves relative the housing. More particularly, the ball bearing 56 is initially disposed toward the top edge 28 of each respective guide rail 18, between the housing 20 and the guide rails 18, at least partially retained in corresponding portions of the housing and guide rails. To this end, each of the guide rails 18 preferably includes a correspondingly configured groove 60, such as a circular groove, while the underside 32 of the housing 20 preferably includes a raised platform 62 with a circular depression 64.

When coupled to one another, the housing 20 and guide rails 18 are disposed such that the groove 60 and circular depression 64 are generally aligned, thereby sandwiching the ball bearing 56 therebetween. Further, the configuration and arrangement of the groove 60 and raised platform 62 is preferably such that the ball bearing 56 is at least partially in abutment with the convex bowed portion 44 of the spring 38 at an initial position. Preferably, the raised platform 62 is at least slightly elevated with respect to the underside 32 as a generally C-shaped cup portion with an open portion thereof being in abutment with the convex bowed portion 44.

More particularly, the ball bearing 56 is retained within the raised platform 62, the majority of which platform is raised from the surface of the underside 32, but which also includes a portion that is open toward and in abutment with the spring 38. At the open portion, the ball bearing 56 is in abutment with the convex bowed portion 44, which maintains the ball bearing within circular depression 64 of the raised platform 62. Thus, when the housing 20 is coupled to the guide rails 18, the ball bearing 56 is held in the circular depression 64 at least partially by the raised platform 62, as well as at least partially by the spring 38 that is coupled to the outer side wall 26 of each of the guide rails.

The guide rails 18 also preferably include an elongated guide track 66 that is configured and arranged such that when the guide rails are coupled to the housing 20, a top end of the guide track receives the ball bearing 56. The guide track 66 is preferably disposed toward an axial center of each of the guide rails 18, and is generally parallel with the inner and outer side walls 24, 28. However, the guide track 66 may be disposed at alternative locations along the guide rail 18 with relation to the spring 36, as will be described. Thus, as the housing 20 and guide rails 18 move relative to one another, the ball bearing 56 begins to rotate within the circular depression 64, thereby promoting reciprocation of the guide track 66 relative to the ball bearing 56.

While only a preferred configuration of the housing 20 is herein illustrated described, it is contemplated that the housing may assume any one of a multitude of configurations depending on the particular handset 10 for which it is designed, which part of the handset in which it is intended to be disposed or attached to, or the particular specifications of the handset for which the sliding assembly 10 is designed. Turning to FIGS. 2, 4 and 5, the housing 20 is preferably generally U-shaped, with legs, designated generally at 68, configured to engage the guide rails 18, and a generally planar joint 70 extending between top portions of the legs.

The legs 68 are generally rectangular in shape, and an underside of the legs is configured to slidingly and matingly receive the respective guide rails 18. To this end, each leg 68 includes inner and outer leg walls 72, 74, wherein an inner width spanning between inner surfaces of the inner and outer leg walls being at least slightly larger than a width of each of the guide rails 18, such that the guide rail having both the spring 38 and the slide rail 40 coupled thereto may be received within the leg.

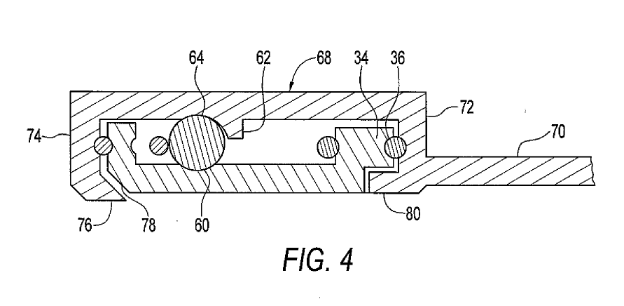

Thus, as illustrated in FIG. 4, each of the guide rails 18 is received between the inner and outer leg walls 72, 74, which also preferably include locking features to lockingly retain the guide rail therein. Specifically, the outer leg wall 74 preferably includes a generally triangular shaped protrusion 76 that extends beneath a beveled portion 78 of the guide rails 18, and the inner leg wall 72 includes a generally rectangular protrusion 80 that extends beneath the shelf 36 created by the flange 34 of the inner side wall 24 of the guide rail. As FIG. 4 also illustrates, the housing joint 70 is preferably elevationally displaced from a top surface of the leg 68.

In sum, each of the guide rails 18 preferably includes the inner and outer side walls 24, 26, with a spring 38 coupled to the outer side wall and a slide rail 40 coupled to the inner side wall. The convex bowed portion 44 of the spring 38 extends outwardly from a hairpin curve 46 of the spring toward an axial center of the receiving surface 22. The U-shaped portions 52, 54 of the slide rail 40 both extend toward the axial center as well. The guide track 66 extends along at least a portion of the length of the guide rail 18 to receive the rotating ball bearing 56 as the housing 20 slides relative to the guide rails in a vertical direction, from a point near the top edge 28 of the guide rail to a predetermined point toward the bottom edge 30.

Each of the guide rails 18 is matingly and slidably received within a respective one of the legs 68, with the raised platform 62 and circular depression 64 retaining the ball bearing 56 therein. As illustrated in FIG. 3, the backbone 42 of the spring 38, which is coupled to the outer side wall 26 of the guide rail 12, abuts an inner surface of the outer leg wall 74, and is retained at least partially by the triangular shaped protrusion 76. Thus, when disposed in the circular depression 64, the ball bearing 56 is retained between the circular depression disposed within the raised platform 62 of the underside 32 of the housing 20 and the guide track 66 disposed in the receiving surface 22 of the guide rail 18. The raised platform 62 biases the ball bearing 56 in a direction of the convex bowed portion 44 of the spring 38.

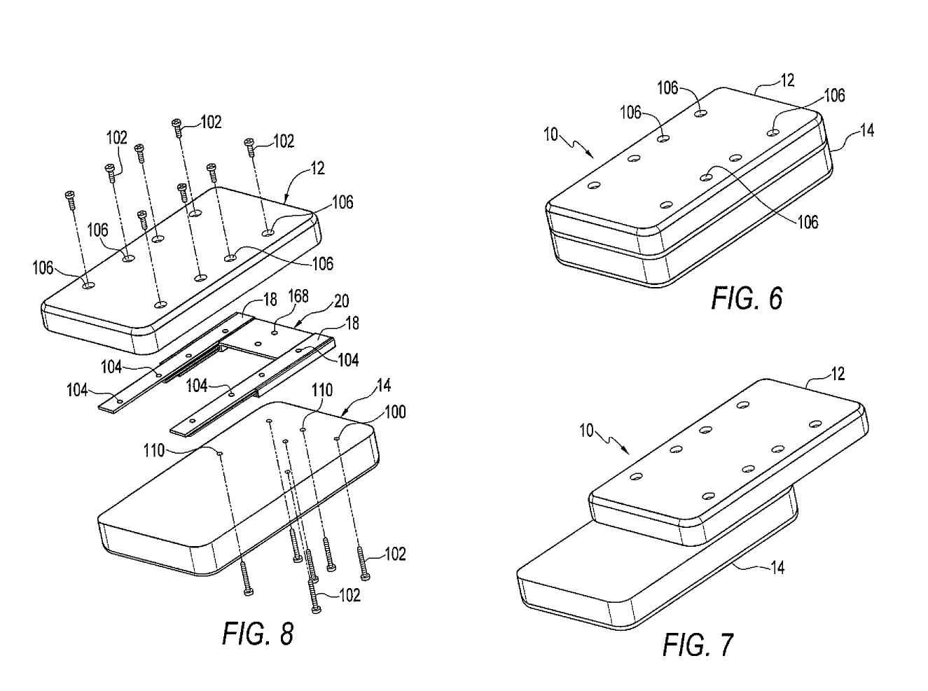

When the handset 10 is in the closed position, which position is illustrated in FIG. 6, the housing 20 and guide rails 18 are oriented so that the ball bearing 56 is disposed between the circular depression 64 within the raised platform 62 a top portion of the guide track 66, where the circular groove 60 is situated. However, when an operator wishes to extend the handset 10 into its partially or fully open position, where the fully open position is illustrated in FIG. 7, the operator may either pull upwardly on that portion of the handset that includes guide rails 18, typically the display part 12, or pull downwardly on that portion of the handset that includes the housing 29, typically the keyboard part 14.

Regardless, when the handset 10 is in the fully closed position, an upper portion of the spring 38 exerts an amount of force, preferably about 0.4N, that must be overcome in order to overcome the inertia of the closed position. As the operator applies enough force to overcome the resistance of the upper portion of the spring 38, the spring will begin to compress. As the spring 38 is compressed, the housing 14 continues to move with respect to the guide rails 18 with the ball bearing 56 aligned with, and moving relative to, the guide track 66 disposed in the receiving surface 22 of the guide rails. Outward forces exerted by the spring 38 are resisted by the force exerted by the circular depression 64 in which the ball bearing 56 rotates and is at least partially retained by the raised platform 62.

As discussed, the spring 38 may be varied greatly without departing from the desirable function of the spring. However, the preferred convex bowed portion 44 provides the additional advantage of promoting a partially assisted opening and closing of the handset 10 in which the sliding assembly 16 is disposed. Specifically, as the housing 10 and ball bearing 56 move relative to the guide rails 18 and guide track 66, the ball bearing meets with increased resistance in a direction away from the spring 38 by the convex bowed portion 44 until the ball bearing reaches a peak 82 that is disposed at a predetermined position along the length of the convex bowed portion, preferably at its midpoint. Therefore, until the ball bearing 56 reaches the peak 82, the handset 10 is urged into its closed position. However, once the operator causes the ball bearing 56 to overcome the force of the convex bowed portion 44 at its peak 82, the ball bearing meets with gradually less force, thereby urging the housing 20 and the ball bearing further downward.

Thus, when the sliding assembly 16 is disposed within the handset 10, the handset is urged toward the open position once the ball bearing 56 passes the peak 82 of the convex bowed portion 44. Conversely, as the operator pushes the housing 20, and consequently the ball bearing 56 disposed therein, upwardly toward the closed position, the application of force sufficient to overcome the force exerted at the peak 82 of the convex bowed portion 44 will urge the handset 10 back into the closed position. In this manner, the preferred configuration of the spring 38 partially assists the operator in extending the handset 10 into its fully open position, or retracting the handset into its fully closed position.

To ensure that the spring 38 compresses in a predetermined manner under predetermined amounts of force, the spring may be designed for specific applications. For example, in the preferred embodiment, the spring 38 is made from music wire, with a displacement of approximately 36 mm between the linear backbone 42 and the peak 82 of the convex bowed portion 44. Approximately 1.8 N are required to compress the spring 38 at this location, whereas approximately 0.4N are required to compress the spring at the detent location to overcome the detent position.

While it is additionally contemplated that the sliding assembly 16 may be configured and dimensioned to suit individual applications, exemplary dimensions and composite materials are provided for purposes of illustration only. It should be understood that dimensions may vary greatly, depending on a variety of factors, including but not limited to the size of the handset in which the sliding assembly 16 will be used, the desired friction, the surface area of the keyboard part 14 to be exposed in the fully open position, and composite materials being adjusted for RF interference. Preferred measurements for the sliding assembly 16 are approximately 30 mm in width, 60 mm in length and 2.0 mm in thickness.

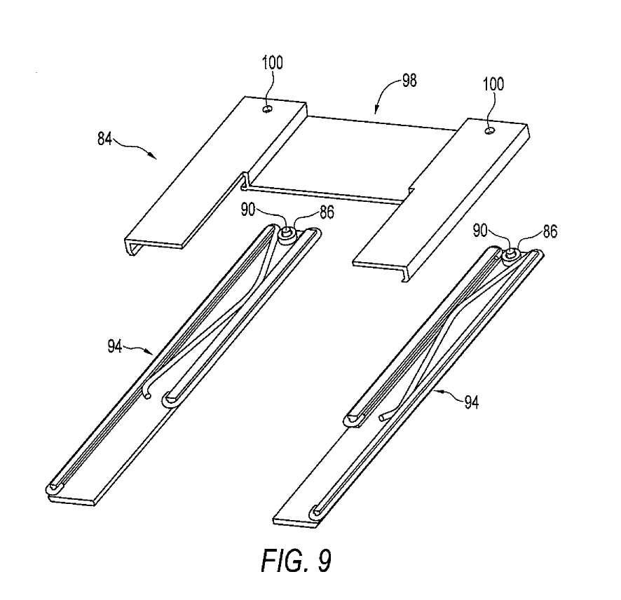

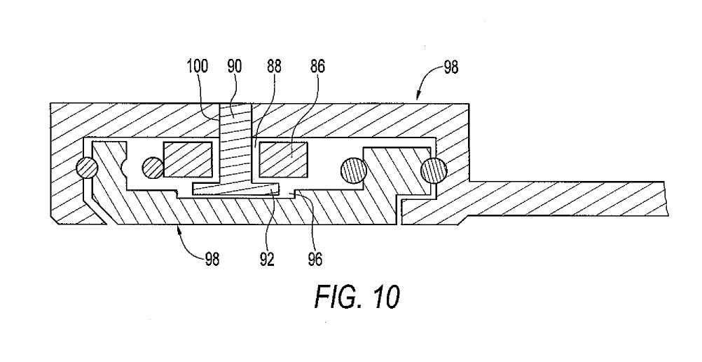

Turning now to FIGS. 9 and 10, a second preferred sliding assembly, designated generally at 84, is illustrated. While the second preferred sliding assembly 84 is similar to the first preferred sliding assembly 16, rather than using the ball bearing 56 as the sliding element, the second preferred sliding assembly provides a rotating member as the sliding element. Specifically, the second preferred sliding assembly 84 includes a wheel 86 having a central orifice 88 is provided, through which central orifice a post 90 extends. As illustrated in FIG. 10, the post 90 is preferably a rivet and includes a generally rectangular base 92. Top and bottom surfaces of the wheel 86 are preferably planar, with the bottom surface abutting a top surface of the rectangular base 92, and a top surface facing upwardly toward the housing 20.

To accommodate the wheel 86 and post 90, the guide rails 94 of the second preferred sliding assembly 84 include a generally rectangular detent 96, which is a generally rectangular recess disposed in the receiving surface 22 thereof, wherein a diameter of the detent is at least slightly larger than that of the rectangular base 92 of the post 90. The wheel 86 is oriented with a bottom surface thereof in abutment with a top surface of the base 92, and with a portion of the outer circumference of the wheel contacting the spring 38 adjacent thereto. Optionally, the elongated and generally rectangular guide track 66 extends downwardly from the detent 96 along the receiving surface 22 of the guide rails 18, and both the post 90 and the wheel 86 that are coupled thereto may move with the housing 20 vertically within the guide track.

The housing 98 of the second preferred sliding assembly 84 includes a mating recess 100 for matingly engaging the post 90. The post 90 extends through the mating recess 100 as illustrated in FIG. 9 and is snugly retained therein to hold the post while allowing the wheel 86 to rotate. The spring 38 exerts an opposing force on the wheel 86, but once the operator exerts sufficient force to overcome the opposing force, the post 90 and the wheel move from a detent shape on the spring 38 and begin traveling along the spring toward a bottom edge 30 of the guide rail 18. The wheel 86 rotates along a surface of the spring 38. Until the wheel 86 reaches the peak 82 of the spring 38, the spring continues to exert an increasing amount of force on the wheel in a direction of the inner side wall 24 of the guide rail 18. However, continued force exerted by the operator will cause the spring 38 to depress, and the wheel 86 and post 90 coupled to the housing 98 will continue downwardly within the guide track 66 until the sliding assembly 84 reaches its fully open position. Returning of the sliding assembly 84 into the fully closed position proceeds similarly by simply reversing the direction of travel of the housing 98, and the wheel 86 and post 90 coupled thereto. Thus, the wheel 86 and post 90 are urged back upward toward the top edge 28 of the guide rail 18.

While the first two illustrated preferred sliding assemblies 16, 84 include a pair of guide rails 18, it is contemplated that a single guide rail would suffice. Moreover, while the pair of guide rails 18 are illustrated and described as being disposed at either side of the housing 20 or 98, and at either side of a handset 10, it is also contemplated that placement of the guide rails may vary according to the particular handset in which it is used. The housing 20 or 98 would similarly be modified to account for the varied placement of the guide rails 18.

With respect to both the first and second preferred sliding assemblies 16, 84, either before or after the guide rails 18 and the housing 20 or 98 are coupled to one another, the guide rails and the housing are coupled to the respective portions of the handset 10. For example, as illustrated in FIGS. 6-8, the guide rails 18 are coupled to the display part 12 of the handset 10 via a plurality of fasteners, preferably threaded fasteners 102, while the housing 20 or 98 is coupled to the keyboard part 14 of the handset via a plurality of fasteners, again preferably the threaded fasteners. More particularly, each of the guide rails 18 preferably includes four orifices 104 at predetermined positions along a length thereof, while the display part 12 of the handset 10 preferably includes four corresponding orifices 106 on each side of the display part. When the display part 12 and the guide rails 18 are aligned, a corresponding number of fasteners such as the threaded fasteners 102, which in the illustrated embodiment is a total of eight, may be threaded through the aligned orifices 104, 106 on the guide rails and the display part, thereby coupling the display part to the guide rails.

Similarly, each of the legs 68 of the housing 20 or 98, as well as the joint 70 of the housing, include at least one and preferably two orifices 108 that correspond to orifices 110 disposed on the keyboard part 12 of the handset 10. When the keyboard part 12 and the housing 20 or 98 are aligned, a corresponding number of threaded fasteners 102, which in the illustrated embodiment is six, may be threaded through the aligned orifices 104, 106 on the housing and the display part, thereby coupling the housing to the display part. Thus, with the sliding assembly 16 or 84 coupled thereto, the handset 10 can be slidingly reciprocated between the fully open position and the fully closed position.

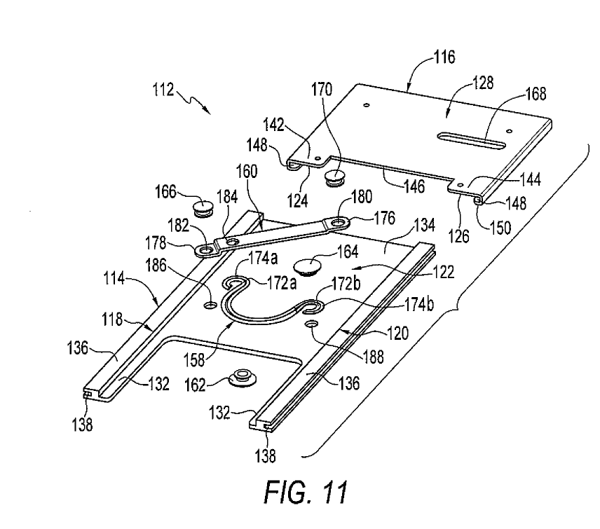

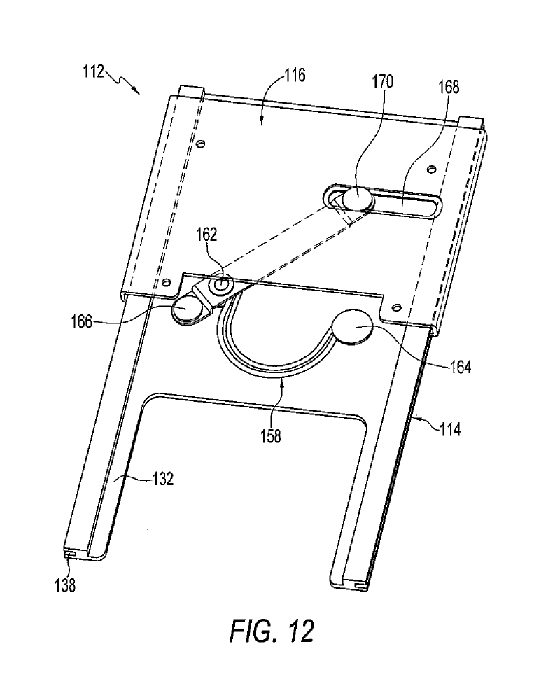

A third preferred sliding assembly, designated generally at 112, is illustrated in FIGS. 11-16. A first slider body, designated generally at 114, is coupled to one of either the display or keyboard part 12, 14 and a second slider body, designated generally 116, is coupled to the other of a display or a keyboard part. The first and second slider bodies 12, 14 are further configured to slidably engage one another, thereby promoting sliding movement of the display and keyboard parts 12, 14 of the handset 10 relative to one another.

More particularly, the first slider body 114 includes at least one and preferably two guide rails 118, 120 and a generally planar first joint, designated generally at 122, disposed therebetween. Similarly, the second slider body 116 includes first and second guide channels 124, 126 that are correspondingly configured to receive and slidably engage the guide rails 118, 120. The second slider body 116 also includes a generally planar second joint, designated generally at 128, which extends between and spans the guide channels 124, 126.

As illustrated in FIGS. 11-13, guide rails 118, 120 of the first slider body 114 are disposed along a length of the first joint 122 at sides thereof, and extend from a bottom edge 130 of the first joint in a direction parallel to the first joint. While it is anticipated that the guide rails 118, 120 may assume a variety of configurations while still imparting slidability with respect to the second slider body 116, a preferred guide rails will be shown and described.

The preferred guide rails 118, 120 include an inner rail surface 132 that is generally coplanar with a receiving surface 134 of the first joint 122, an elongated raised track 136 that extends generally along a length of the guide rails 118, 120 and is elevationally displaced from the inner rail surface, and a locking groove 138 is disposed at outer sides of the guide rails.

The second joint 128 of the second slider body 116 is generally rectangular, with generally rectangular side legs 142, 144 extending outwardly at sides and downwardly along a length thereof. The side legs 142, 144 preferably extend at least partially downwardly from a bottom edge 146 in a direction generally parallel to a plane of the second joint 128. Outer sides of the side legs 142, 144 are preferably configured and dimensioned to engage the locking grooves 138 of the guide rails 118, 120, and as such, each outer side preferably includes U-shaped guide channel 148 such that an inwardly extending flange 150 extends inwardly from a bottom of the U-shaped guide channel in a direction generally parallel to the second joint 26 to engage the guide rails 16, 18.

Thus, the first and second slider bodies 114, 116 are coupled to one another as the inwardly extending flange 150 of the second slider body engages the locking groove 138 of the first slider body, thereby slidably retaining the raised track 136 within the U-shaped guide channels 148. In this way, the first and second slider bodies 114, 116 are slidably coupled to promote sliding movement relative to one another, which is to say that either the first slider body may slide relative to the second slider body or the second slider body may slide relative to the first slider body along an entire length of the guide rails 118, 120 and the U-shaped guide channels 148.

To enhance an operator's ability to selectively slide open and slide closed a handset in which the third preferred sliding assembly 112 is disposed, a biasing assembly is provided to alternatively bias the handset in a fully open or fully closed position by providing a partially assisted opening and closing of the handset.

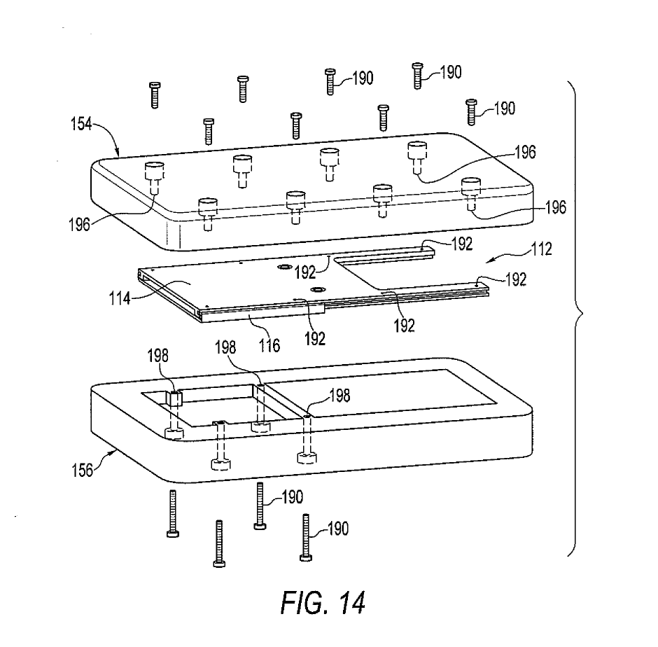

As illustrated in FIG. 14, the third preferred sliding assembly 112 is disposed within a handset, designated generally at 152, with one of either the first or second slider bodies 114, 116 disposed on a display part, generally at 154, and the other of the first or second slider bodies disposed on a keyboard part, generally at 156. For purposes of illustration, the first slider body 114 is shown as being coupled to the display part 154 while the second slider body 116 is shown as being coupled to the keyboard part 156.

The biasing assembly includes features disposed on both of the first and second slider bodies 114, 116 that enhance the operator's control over the opening and closing of the handset 152. More specifically, the first slider body 114 includes at least one biasing member, generally at 158, a pivoting linking arm, generally at 160, and a plurality of fasteners, such as first, second and third rivets 162, 164, 166, while the second slider body 116 includes an elongated slot 168 configured to receive an engagement rivet 170 connected to the linking arm 160, which slidably reciprocates within the elongated slot.

While it is contemplated that the biasing member 158 may assume a variety of configurations, the preferred biasing member is at least one and preferably two concentric, arcuate inner and outer torsion springs 172, 174 that are configured to have left curved end portions 172a, 174a and right curved end portions 174a, 174b for lockingly engaging the first and second rivets 162, 164, respectively. The pivoting linking arm 160 is generally rectangular in shape, with upper and lower radiused ends 176, 178, wherein the upper and lower radiused ends are elevationally displaced from a body of the linking arm in opposite directions. The linking arm 160 preferably includes an upper radiused end orifice 180, a lower radiused end orifice 182, and a third orifice 184 that is preferably disposed at an end of the linking arm near the lower radiused end 178. Advantageously, the location of the third orifice 184 may vary to suit individual applications, where the third orifice may be disposed at varying positions along a length of the linking arm 160. Additionally, the receiving surface 134 of the first slider body 114 preferably includes left and right receiving surface orifices 186, 188.

When assembled, the torsion springs 172, 174 are in abutment with the receiving surface 134 such that a radius of the torsion springs are parallel to the receiving surface. The first rivet 162 is coupled to the left curved end portions 172a, 174a of the inner and outer torsion springs 172, 174 and the third orifice 184 of the linking arm 160, while second rivet 164 couples the right curved end portions 172b, 174b to the right receiving surface orifice 188. Thus, altering the position of the third orifice to suit individual applications has the effect of either increasing or decreasing tension on the torsion springs 172, 174 during movement of the linking arm 160. The third rivet 166 couples the lower radiused end orifice 182 of the linking arm 160 to the left receiving surface orifice 186 of the receiving surface 134. The engagement rivet 170 is coupled to the upper radiused end orifice 180 as well as the elongated slot 168.

The second slider body 116 includes the elongated slot 168 that extends generally from generally a midpoint of the second joint 128 toward one of the outer edges of the second joint. The elongated slot 168 is sized and configured to matingly engage the engagement rivet 170 and permit sliding reciprocation of the engagement rivet therein. In the third preferred embodiment, the engagement rivet 170 is coupled to both the upper radiused end 176 of the linking arm 160 and the elongated slot 168. In this manner, the second slider body 116, which is engaged with the first slider body 114 via engagement of the guide rails 118, 120 to the U-shaped guide grooves 148, is also lockingly engaged to the first slider body such that the first and second slider bodies may move relative to one another.

Thus, the first slider body 114 is coupled to both the inner and outer torsion springs 172, 174 and the linking arm 160, and the linking arm is coupled to all three of the first slider body, torsion springs, and second slider body 116, thereby lockingly securing the first and second slider bodies to one another.

During operation, the operator exerts a predetermined amount of force to overcome a force of the inner and outer torsion springs 172, 174 when the operator commences sliding the first and second slider bodies 114, 116 relative to one another, thereby permitting reciprocation of the linking arm 160 within the elongated slot 168 via the engagement rivet 170. Additionally, while the third preferred sliding assembly 112 may be configured such that an initial position where top edges of the first and second slider bodies 114, 116 are generally aligned with one another is either the fully open or fully closed position, for purposes of illustration and convention, the initial position will be described as the fully closed position. With respect to the drawings, the conventions of “right” and “left” and “clockwise” and “counterclockwise” will be used for purposes of illustration, although it is contemplated that alternative configurations of the third preferred sliding assembly 112 could reverse or otherwise modify the illustrated conventions.

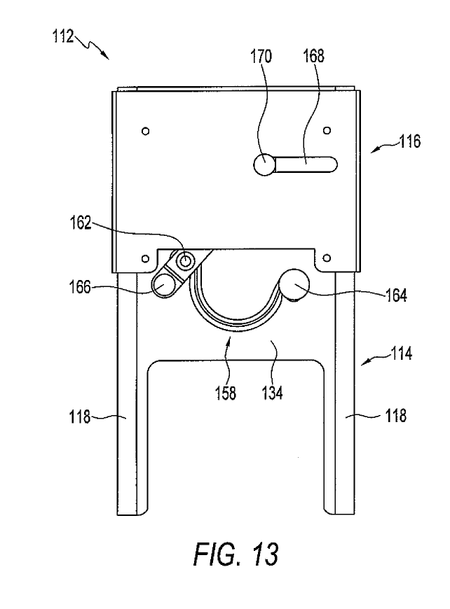

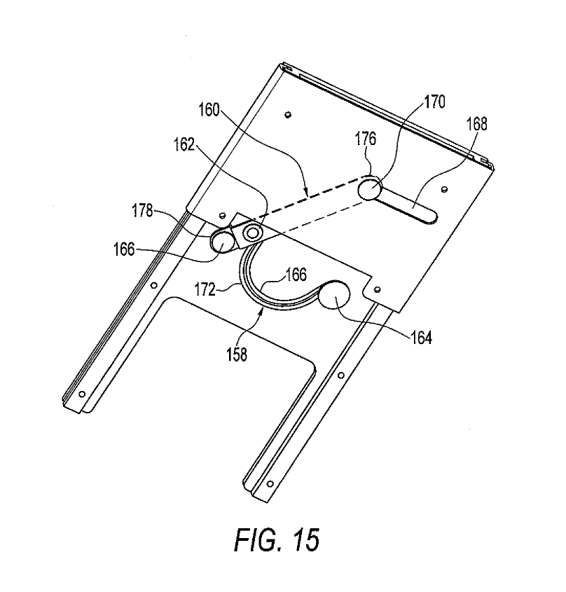

As illustrated in FIGS. 13 and 15, the third preferred sliding assembly 112 is illustrated in the fully closed position, with top edges of the first and second slider bodies 114, 116 in alignment with one another, and the engagement rivet 170 in the extreme leftward position within the elongated slot 168.

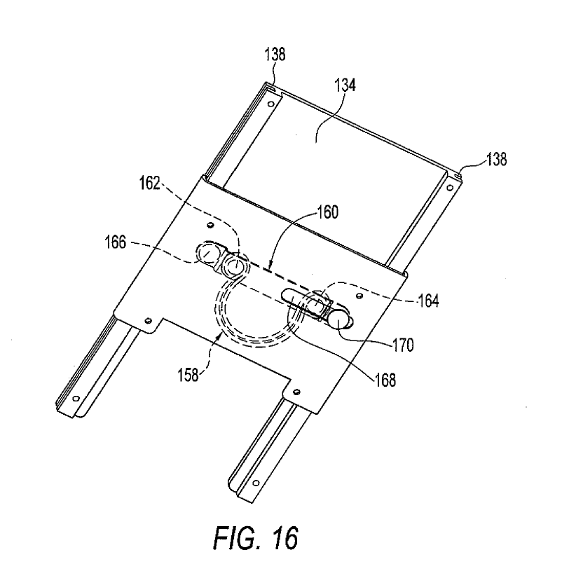

While the first and second slider bodies 114, 116 are each configured to move relative to one another, for purposes of illustration, the second slider body will be discussed as moving relative to the first slider body. Accordingly, when the second slider body 116 begins to move relative to the first slider body 114, and enough force is applied to overcome the preload forces of the inner and outer torsion springs 172, 174, the linking arm 160 begins to rotate in a clockwise direction and the engagement rivet 170 begins to slide within the elongated slot 168 in a rightward direction. While the predetermined force required to overcome the force of the inner and outer torsion springs 172, 174 may be tailored to suit individual applications, the preferred torsion springs are under a preload force of approximately 0.5 N. As illustrated in FIG. 16, the engagement rivet 170 moves rightward during movement of the third preferred sliding assembly 112 toward the fully open position.

As the first and second slider bodies 114, 116 are moved relative to one another, the engagement rivet 170 moves within the elongated slot 168 and the lower radiused end 178 of the linking arm 160 pivots within the second receiving surface orifice 184, thereby rotating the linking arm. As the linking arm 160 rotates, the curved end portions 172b, 174b of the torsion springs 172, 174 that is coupled to the linking arm via third rivet 166 is urged toward the curved end portions 172a, 174a, thereby compressing the torsion springs 172, 174. The second slider body 116 may slidably move relative to the first slider body 114 until the engagement rivet 170 encounters an opposite end of the elongated slot 168, which as illustrated in FIG. 16, is the extreme rightward position of the elongated slot. Thus, each end of the elongated slot 168 acts as a hard stop for the reciprocation of the engagement rivet 170 therein.

As the linking arm 160 rotates in a clockwise direction, it encounters increasing resistance by the inner and outer torsion springs 172, 174 until the engagement rivet 170 is in the extreme rightward position, where the sliding assembly 112 is at its mid-point position, and the inner and outer torsion springs are maximally compressed under a predetermined load, such as approximately 1.5N. In the mid-point position, force exerted by the inner and outer torsion springs 172, 174 on the linking arm 160 bias the linking arm equally toward both the fully open and fully closed position.

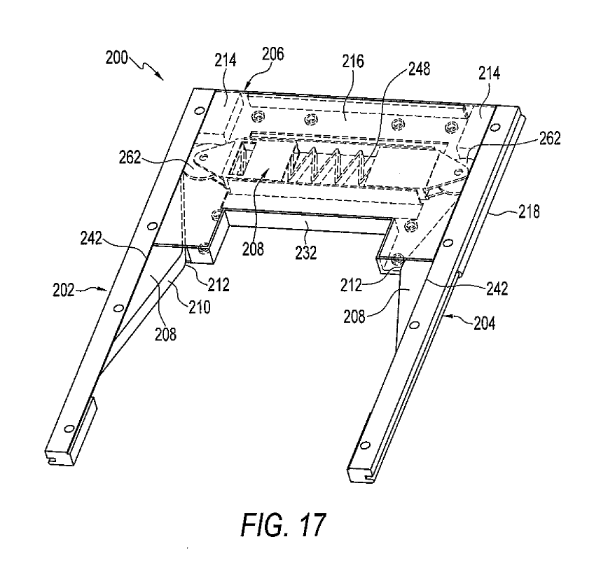

Therefore, if the operator continues to slide the second slider body 116 into the open position, the linking arm 160 will continue to rotate in a clockwise direction, past a point where the linking arm is generally parallel to the elongated slot 168, causing the engagement rivet 170 to move in a leftward direction as illustrated in FIG. 17. Once the operator pushes past the mid-point position toward the fully open position, the inner and outer torsion springs 172, 174 will urge the continued clockwise rotation of the linking arm 160 until the engagement rivet 170 is moved into the leftward hard stop position. Thus, if the operator commences sliding of the first and second members 114, 116 relative to one another toward the fully open and fully closed positions, and exerts enough force to overcome the mid-point position, the inner and outer torsion springs 172, 174 will provide a “partial assist” in opening the sliding assembly 112 the remainder of the way into the fully open position.

Similarly, beginning with the sliding assembly 112 in the fully open position, when the operator chooses to slide the first and second slider bodies 114, 116 toward the fully closed position, the inner and outer torsion springs 172, 174, which in the fully open position bias the sliding members in the fully open position, exert the same predetermined force, for example, 0.5N. Once this force is overcome, the first and second slider bodies 114, 116 may slide relative to one another, thereby moving the linking arm 160 in a counterclockwise direction, which in turn causes the engagement rivet 170 to move toward the extreme rightward position. At the extreme rightward position, the mid-point position, the torsion springs are under a load of approximately 1.5N. If the operator continues exerting force sufficient to overcome the mid-point position toward the fully closed position, the inner and outer torsion springs 172, 174 will begin to bias the first and second slider bodies 114, 116 into the fully closed position by urging the linking arm 160 into continued counterclockwise rotation. Thus, a “partial assist” is also provided to the operator in sliding the sliding assembly 112 into the fully closed position. The inner and outer torsion springs 172, 174 urge the counterclockwise rotation of the linking arm 160 until the engagement rivet 170 is once again in the extreme leftward hard stop position. At this point, the sliding assembly 112 is in the fully closed position.

While the sliding assembly 112 may be configured to have dimensions and composite materials to suit particular specifications, the preferred embodiment includes predetermined dimensions and composite materials that optimize both the overall size and weight of the sliding assembly.

For example, the first slider body 114 is preferably made of aluminum while the second slider body 116 is preferably made from stainless steel. The linking arm 160 is also preferably made from stainless steel, while both of the inner and outer torsion springs 172, 174 are preferably made from music wire. Additionally, the first, second and third rivets 162, 164, 166, as well as the engagement rivet 170, are preferably made from stainless steel.

A length of the entire sliding assembly 112 generally corresponds to a length of the first slider body 114 insofar as top edges of the first and second slider bodies 114, 116 are generally aligned when coupled to one another in the fully closed position. This length is measured from a top edge to a bottom edge of the guide rails 118, 120 and is approximately 65.6 mm. Similarly, a width of the sliding assembly 112 generally corresponds to a width of the second slider body 116 as measured between outer sides, and is approximately 38.4 mm. A thickness of the assembled sliding assembly 112 is approximately 3.0 mm.

Either before or after the first and second slider bodies 114, 116 are coupled to one another, the first and second slider bodies are coupled to the respective portions of the handset 152 (FIG. 14). For example, in FIG. 14, the first slider body 114 is shown as being coupled to the display part 154 via a plurality of fasteners, preferably threaded fasteners 190, while the second slider body 116 is shown as being coupled to the keyboard part 156 via a plurality of fasteners, again preferably threaded fasteners.

More particularly, as illustrated in FIG. 14, the first slider body 114 preferably includes eight first slider body orifices 192 at predetermined positions along a length thereof, while the second slider body 116 preferably includes four second slider body orifices (not shown) at predetermined positions thereon. Similarly, the display part 154 includes a number of display part orifices 196, preferably eight, that are configured to correspond and align with the first slider body orifices 192 disposed on the first slider body 114. The keyboard part 156 also includes a plurality of keyboard part orifices 198 that correspond to the second slider body orifices 194 of the second slider body 116. Thus, the first slider body 114 may be coupled to the display part 154 via threaded fasteners 190 inserted into the first sliding member orifices 192 and the display part orifices 196, and the second slider body 116 may be coupled to the keyboard part 156 via threaded fasteners 190 inserted into second sliding member orifices 194 and keyboard part orifices 198.

A fourth embodiment of the sliding assembly, designated generally at 200, is illustrated in FIG. 17. First and second guide rails, generally at 202, 204, are configured to correspond to, and be slidably engaged with, a slider body, generally at 206. A biasing assembly, generally at 208, is also preferably provided to bias the handset in which the sliding assembly 200 is disposed into the fully open and fully closed positions, which provides the operator with a partial assist in opening and closing the handset.

First and second guide rails 202, 204 may be configured to suit individual applications, and various configurations will be herein shown and described for purposes of illustration. For example, in the preferred sliding assembly 200, first and second guide rails 202, 204 are each generally rectangular in shape, with each guide rail including a guide track 210 disposed generally along a length thereof. While the guide tracks 210 may be configured and arranged in accordance with individual specification, one preferred configuration and arrangement includes a longitudinal groove extending in a generally V-shaped configuration, with a biasing point 212 being disposed generally at a midpoint of the guide tracks. At top ends of each of the guide rails 202, 204 are generally rectangular shaped guide extensions 214, which preferably have a width corresponding to a width of the guide track 210 at the biasing points 212.

Additionally, the first and second guide rails 202, 204 include features configured to promote relative sliding movement of the slider body 206. The slider body 206 preferably includes top and bottom housings 216, 218 configured to be matingly engaged to one another such that the top and bottom housings at least partially enclose the first and second guide rails 202, 204 and the biasing assembly 208. Each of the top and bottom housings 216, 218 have generally planar outer surfaces 220, 222. The top housing 216 includes top leg extensions 224 corresponding to the first and second guide rails 202, 204. Similarly, the bottom housing 218 includes bottom leg extensions 226 corresponding to the guide rails 202, 204 and to the top leg extensions 224.

As illustrated in FIG. 17, the guide rails 202, 204 are oriented within the top and bottom housings 216, 218 such that guide tracks 210 are oriented to be generally coextensive with the bottom leg extensions 226, preferably with a majority of the length of the guide rails extending from the bottom housing in a direction parallel to, and in alignment with, the bottom leg extensions. In order to promote sliding movement of the guide rails 202, 204 with respect to the bottom housing 218 in a direction of the bottom leg extensions 226, top and bottom ends of the bottom housing include top and bottom openings 228, 230 to accommodate at least a width of each of the guide rails at their widest part. As illustrated in the preferred sliding assembly 200, the widest parts of the guide rails 202, 204 are the biasing point 212 of the guide track 210 and the guide extensions 214, which are generally equal in width. Preferably the top and bottom openings 228, 230 are sized and configured to correspond to a width of each of the guide rails 202, 204 at the biasing points 212 and guide extensions 214 such that the guide rails matingly engage and are at least partially retained within the top and bottom openings.

The top housing 216 and bottom housing 218 are coupled to one another such that they at least partially enclose the guide rails 202, 204 and the biasing assembly 208. To this end, the top housing 216 engages the guide rails 202, 204 similarly to the manner in which the bottom housing 218 engages the guide rails. Like the bottom housing 218, the top leg extensions 224 of the top housing 216 are configured and arranged to slidably receive the guide rails 202, 204 therein, and to permit sliding movement of the guide rails with respect to the top housing.

Additionally, the top and bottom housings 216, 218 are configured to be coupled to one another, and accordingly include features to promote the coupling. As illustrated in FIG. 17, the preferred bottom housing 218 includes a generally U-shaped upwardly extending flange 232 at least defined by inner sides of the bottom leg extensions 226. Similarly, the top housing 216 preferably includes a generally U-shaped downwardly extending flange 234 at least defined by inner sides of the top leg extensions 224. An upwardly extending rear flange 236 is also preferably provided with the bottom housing 218. The upwardly extending flange 232 and downwardly extending flange 234 are correspondingly configured such that when the top and bottom housings 216, 218 are coupled to one another, an outer surface 238 of the downwardly extending flange abuts an inner surface 240 of the upwardly extending flange.

Thus, when coupled to one another, the U-shaped upwardly and downwardly extending flanges 232, 234 are brought into abutment. A height of the two flanges 232, 234 generally corresponds to a height of the guide rails 202, 204, and a height of the rear flange 236 also generally corresponds to the height of the guide rails, such that when the top and bottom housings 214, 216 are coupled, the guide rails may be accommodated therebetween along a length of the top and bottom housings in alignment with the top and bottom leg extensions 224, 226.

Each of the guide rails 202, 204 also preferably includes a top channel 242 along a length thereof, in which top channel an outer edge of the top housing 216 is matingly received. In addition, outer sides of the guide rails 202, 204 each include a sliding groove 244 in which a preferably curved flange 246 of the bottom housing is matingly received. While an outer edge of the top housing 216 is snugly received within the top channel 242 and the curved flange 246 of the bottom housing 218 is snugly received within the sliding grove 244, the engagement of both top and bottom housings in this manner promotes sliding movement of the top and bottom housings relative to the guide rails 202, 204 while maintaining engagement of the top and bottom housings to the guide rails.

While the guide rails 202, 204 may slidably move relative to the assembled slider body 206, the biasing assembly 208 is provided to provide biasing forces to bias the sliding assembly 200 into discrete positions, such as the fully opened and fully closed positions, for example.

More particularly, turning to FIG. 17, the biasing assembly 208 of the preferred sliding assembly 200 includes at least one spring 248 configured to exert outward forces in a direction of each of the guide rails 202, 204. While it is contemplated that the number of springs provided, as well as the configuration of each of the springs, may vary to suit individual applications, in one preferred sliding assembly the spring 248 is an accordion spring, preferably sinusoidal in shape, having a generally “W” shape with rounded bends.

The preferred biasing assembly 208 also includes a spring housing, designated generally at 250, which at least partially houses the spring 248 and includes features that operably engage the guide rails 202, 204 to promote sliding movement relative thereto. The spring housing 250 preferably includes a left and a right members, generally at 252, 254, which are configured to move relative to one another in a direction of the biasing forces of the spring 248 as the spring biases them apart.

While the left and right members 252, 254 may assume a variety of configurations to suit individual applications, in one preferred embodiment, the left and right members are generally rectangular boxes open on at least one open end 256 to receive an end of the spring 248 therein, and at least partially closed at an end opposite the at least one open end to retain the end of the spring therein. Preferably, the left and right members 252, 254 are mirror images of one another, such that open ends are configured to face one another, with respective ends of the spring 248 being retained within the left and right members.

In turn, the left and right members 252, 254 are retained within the slider body 206 at either one or both of the top and bottom housing 216, 218. More specifically, as illustrated in FIG. 17, the bottom housing 218 preferably includes upwardly extending walls 258, where a width between the upwardly extending walls corresponds generally to that of the left and right members 252, 254 to snugly retain the left and right members therein.

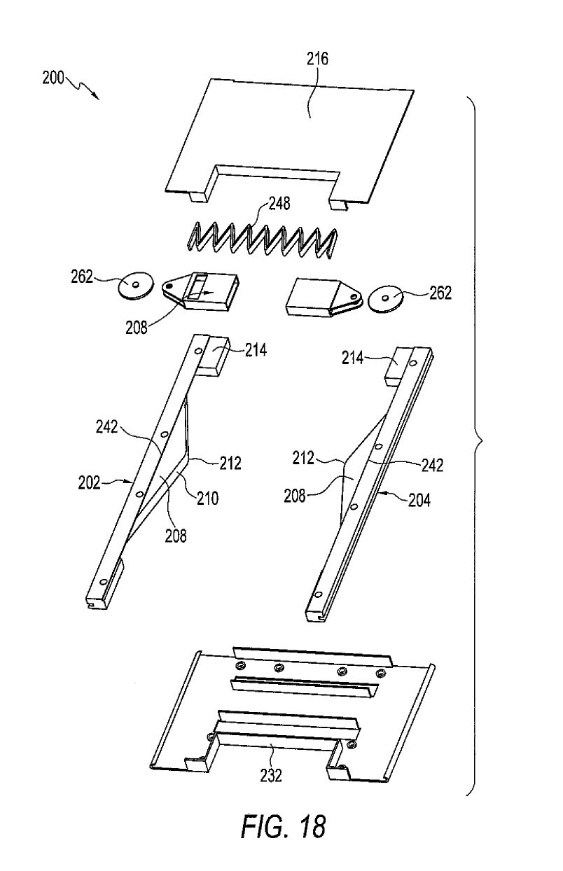

At ends of the left and right members 252, 254 opposite the open ends 256, each of the right and left members preferably includes an engagement assembly for engaging the guide rails 202, 204 and sliding relative thereto. As illustrated in FIG. 18, each of the left and right members 252, 254 includes a generally triangular extension 260 with a roller wheel 262 coupled thereto, where the roller wheel is configured to roll along the guide track 210 of each of the guide rails 202, 204. While the roller wheel 262 may be coupled to the triangular extension 260 in a number of ways, one preferred embodiment includes posts 264 extending axially from a top and bottom of the roller wheel through corresponding orifices 266 in the triangular extension 260.

To illustrate exemplary operation the sliding assembly 200 of the fourth embodiment, certain conventions shall be used. For example, while “top” and “bottom” and “open” and “closed” may be assigned to various locations of the sliding assembly 200, for purposes of illustration, the “top” will refer to an end of the assembly where the guide extensions are located, and the closed position will be discussed as being that position corresponding to the a position where a top edge of the slider body 206 is at its extreme top position.

Thus, starting with the sliding assembly 200 in its fully closed position, the top and bottom housings 216, 218 are coupled to one another, with the rear flange 236 of the bottom housing parallel to a top edge 266 of the guide extensions 214. At this point, the spring 248 exerts a predetermined force, which must be overcome to commence sliding movement of the sliding assembly. While the force may vary to suit individual application, one preferred force is approximately 1N. As the user exerts a sufficient downward force on the slider body 206 relative to the guide rails 202, 204, the spring 248 force is overcome and the roller wheel 262 will begin to rotate and roll along the guide tracks 210, thereby slidably moving the slider body 206 with respect to the guide rails. Because the guide tracks 210 are generally V-shaped, the user is pulling the roller wheel 262 “uphill” toward the biasing point 212, thereby gradually compressing the spring 248 and requiring additional increments of force to continue moving the roller wheel.

Once the user exerts sufficient force to bring the roller wheel 262 into alignment with the biasing point 212, the spring 248 is maximally compressed. If the user pushes the roller wheel 262 past the biasing point 212, the spring 248 will urge the roller wheel “downhill” to the other end of the guide track 210 where the sliding assembly 200 is then in its fully open position. In this manner, the biasing assembly 208 of the preferred sliding assembly 200 provides a partial assist to the user during the opening operation, in that once the sliding assembly is opened past a predetermined point, such as the biasing point 212, the sliding assembly will be urged into the fully opened position.

Similarly, the preferred sliding assembly provides a partial assist to the user during the closing operation as well. One the user applies sufficient upward force to overcome the force of the spring 248, the roller wheel 262 will commence traveling “uphill” toward the biasing point 212, after which biasing point the roller wheel will commence traveling “downhill,” thereby urging the sliding assembly back into the fully closed position.

While the preferred fourth embodiment was shown and described, variations may be made without departing from the operation of the sliding assembly.

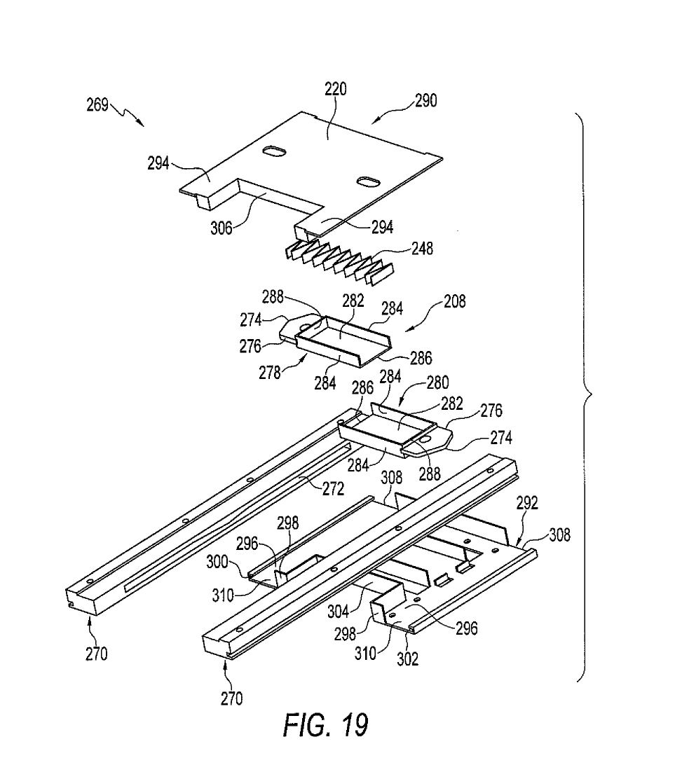

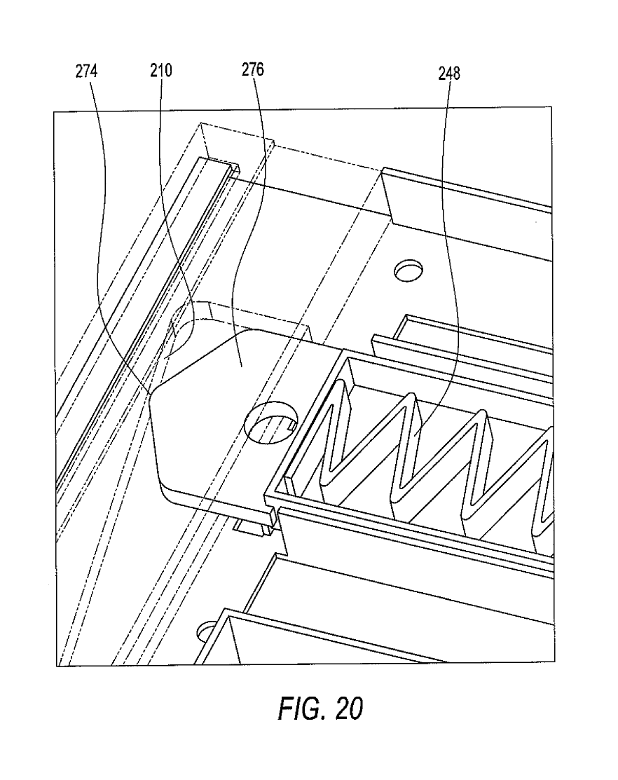

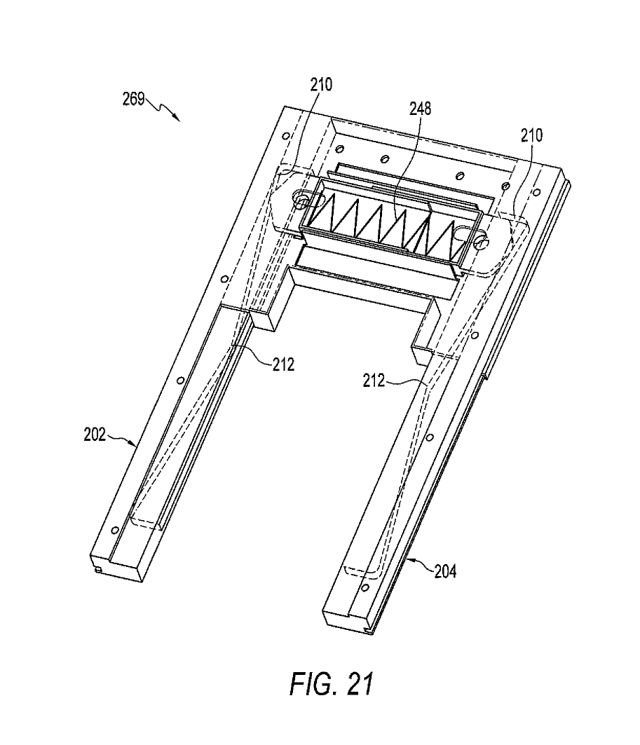

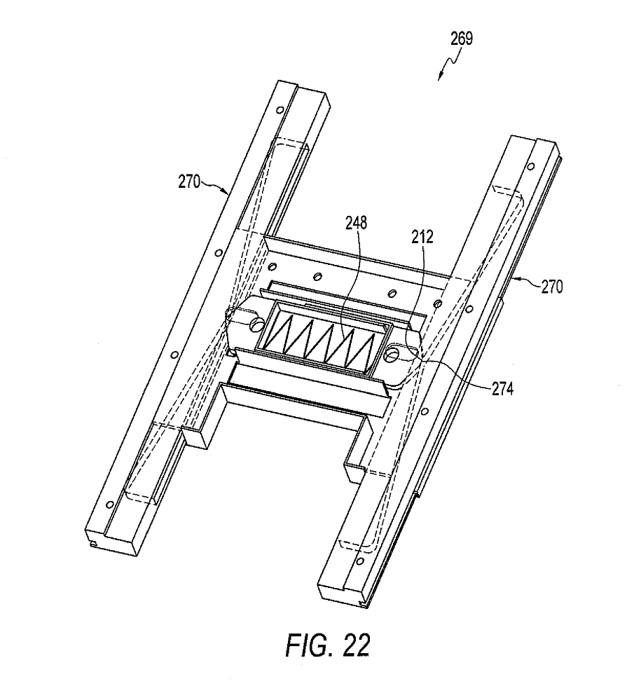

For example, as illustrated in FIGS. 18-22, another alternative embodiment of the sliding assembly 269 provides guide rails 270 that may be generally rectangular with a guide track 272 recessed within the guide rail. Additionally, rather than engaging the roller wheel 262, the recessed guide track 272 may engage a rounded tip 274 of a triangular extension 276.

More particularly, each of an alternative left and right member 278, 280 include a generally rectangular receiving surface 282 bound at sides by side walls 284, where widths of the respective receiving surfaces are configured such that one of the left and right members slidably receives the other of the left and right members. As shown, the left member 278 is received by the right member 280, though it is contemplated that the opposite configuration may be adopted as well. Thus, mating ends 286 of each of the left and right members 278, 280 are open. When engaged to one another, the left and right members 278, 280 therefore combine to form the generally rectangular receiving surfaces 282 that abuts the spring 248, which is retained at its ends by retaining walls 288 disposed on each of the left and right members 278, 280.

Additionally, the top and bottom housings 290, 292 include respective top and a bottom leg extensions 294, 296, which in turn preferably include respective retaining flanges 298 extending from an inner side of the leg extensions toward the outer side of the leg extensions. At an outer side of each of bottom leg extensions 296 is an outer elongated channel 300, 302, where the guide rails 270 are retained at their sides by the elongated channels on the outer sides and by the retaining flanges 298. U-shaped upwardly and downwardly extending flanges 304, 306 are disposed at inner sides of the top and bottom leg extensions 294, 296. Top and bottom ends 308, 310 of the bottom housing 292 are configured to be open to promote sliding reciprocation of the guide rails 270 within the assembled top and bottom housings 290, 292 of the slider body 206.

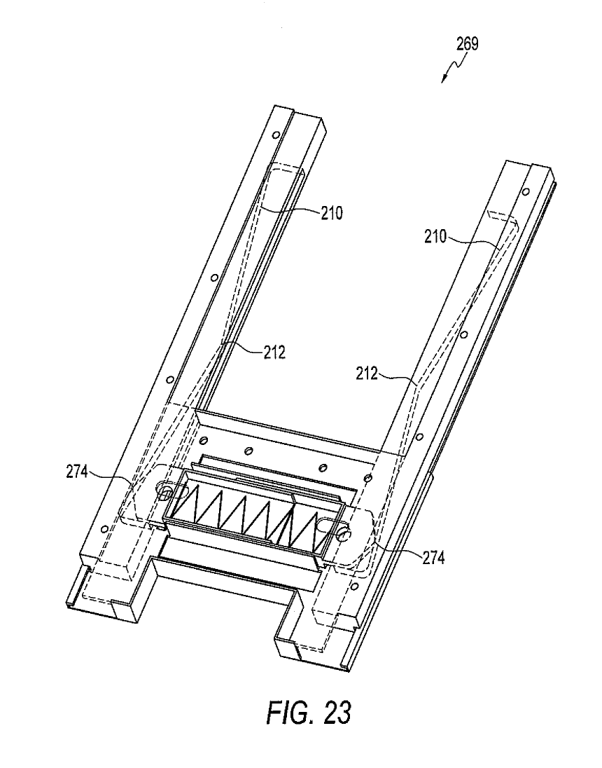

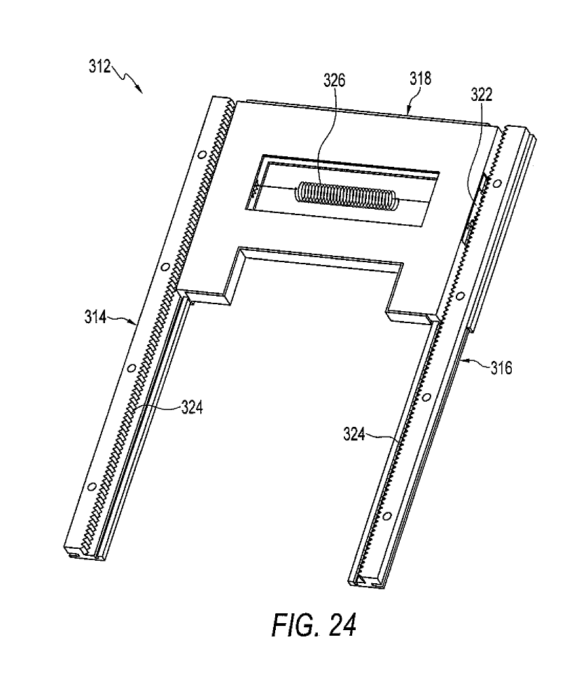

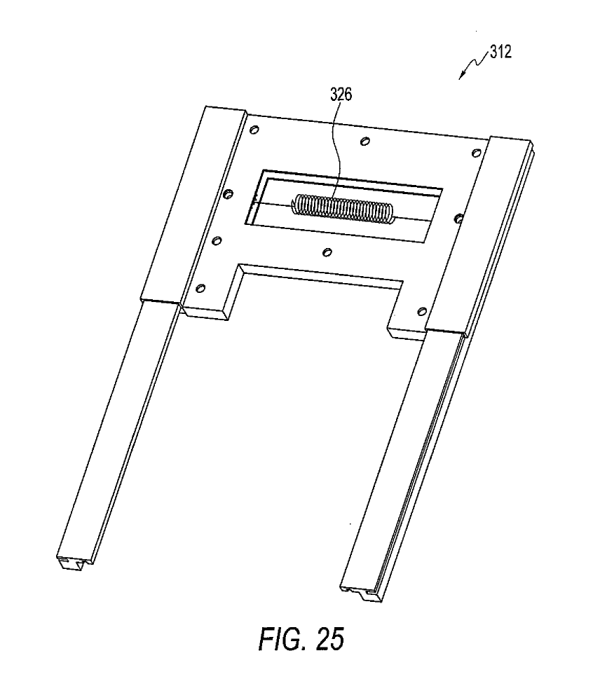

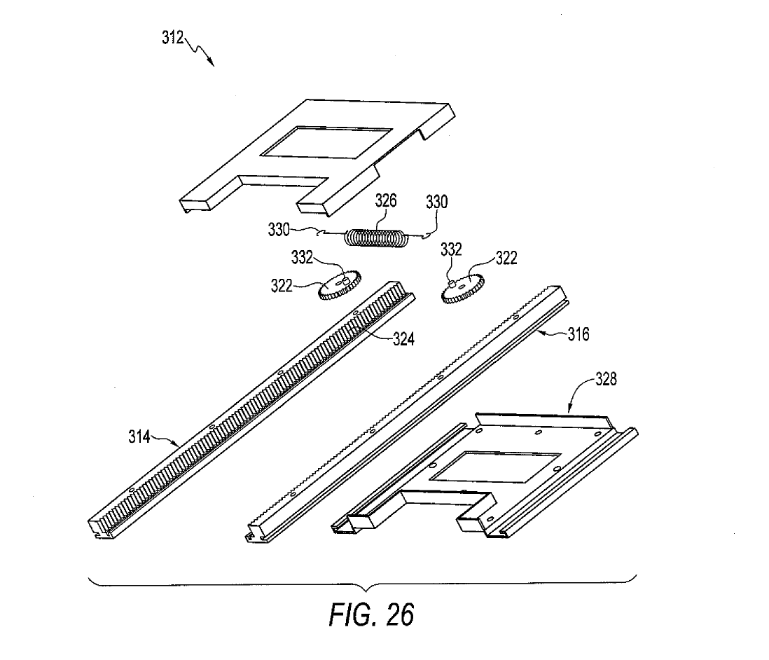

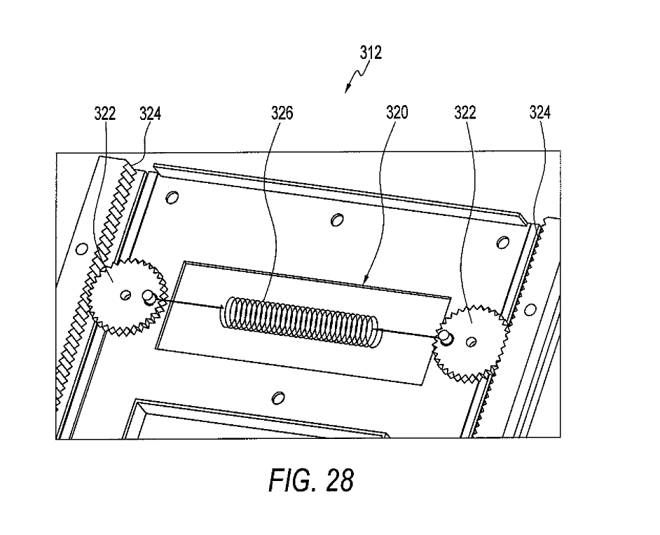

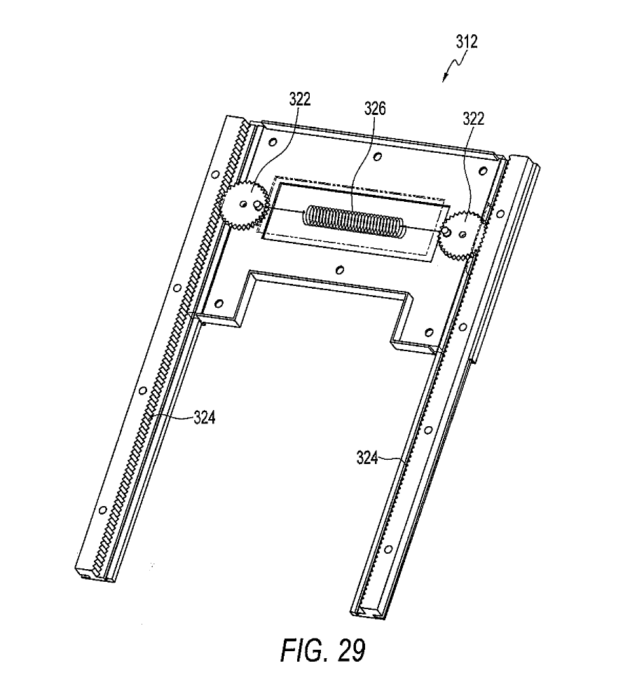

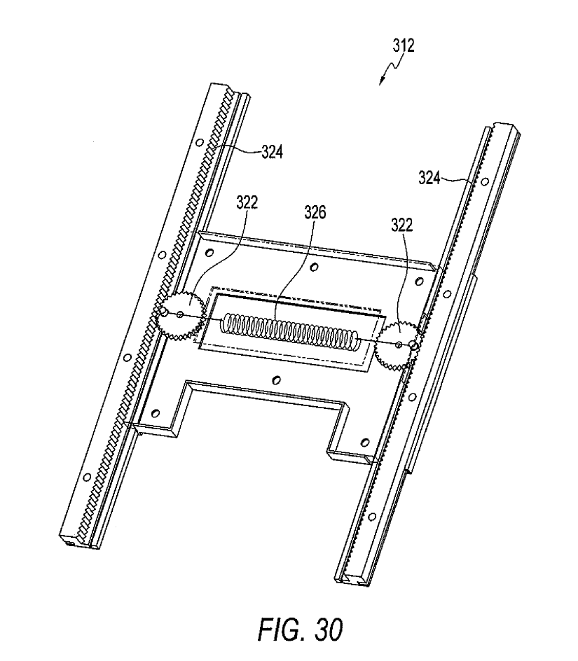

FIGS. 23 through 30 illustrate a sliding assembly according to still another preferred embodiment, designated generally at 312. Like the previous embodiment sliding assembly 200, the instant embodiment includes first and second guide rails, generally at 314, 316, which are configured to correspond to, and be slidably engaged with, a slider body, generally at 318. A biasing assembly, generally at 320, is also preferably provided to bias the handset in which the sliding assembly 312 is disposed into the fully open and fully closed positions, which provides the operator with a partial assist in opening and closing the handset.

The biasing assembly 320 of the instant embodiment includes at least one gear 322 that travels vertically along a length of each of the guide rails 314, 316 in a gear track 324 that is disposed along the length of the guide rails. Each of the gears 322 is configured to have a predetermined outer circumference, such that one full revolution of the gear represents a range of vertical motion for the sliding assembly 312. Accordingly, varying the size of the outer circumference of the gears 322 correspondingly varies the range of vertical motion of the sliding assembly 312, where a relatively larger outer circumference generally provides a larger range of motion and a relatively smaller outer circumference generally provides a smaller range of motion.

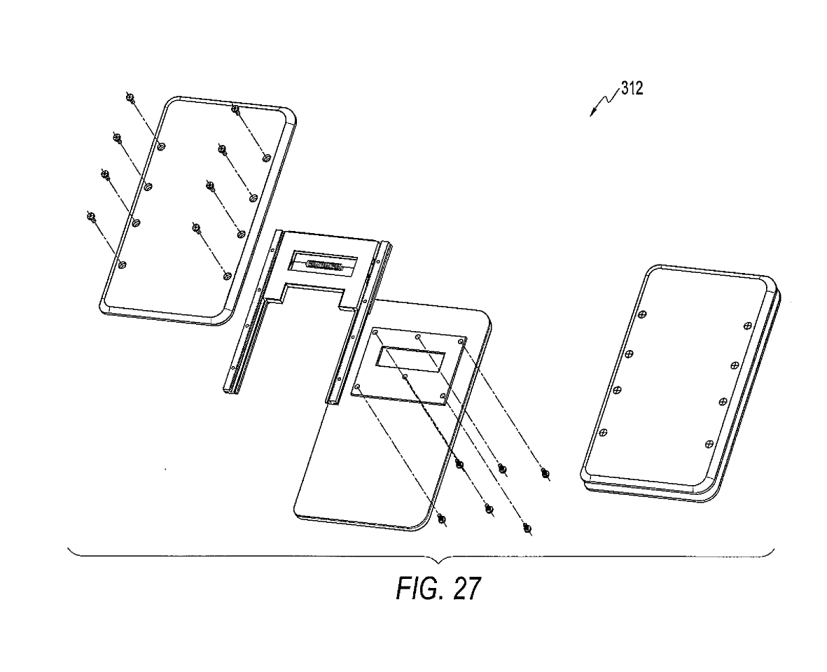

The biasing assembly 320 additionally includes at least one spring 326 to provide tension between the at least gear 322 and a bottom housing 328 of the slider body 318, or alternatively between the gears disposed on either side of the bottom housing. For example, as illustrated in FIGS. 27, a tension spring is coupled to each of the two gears 322, with loops 330 disposed at ends of the spring 326 matingly coupled to pins 332. The pins 332 are preferably eccentric to a rotational axis of the gears 322. FIG. 23 illustrates the sliding assembly 312 in a fully closed position, in which position the gears 322 are oriented such that a distance between the pins 332 is at its smallest measurement and minimal force is therefore exerted on the spring 326 disposed therebetween.

Thus, to operate the sliding assembly 312, the user would exert enough downward force to commence rotation of the gears 322 with respect to the gear track 324, thereby exerting force on the spring 326 to stretch of the spring. As the gears 322 turn, the pins 332 move farther apart until they a maximally displaced from one another after each rotates 180° from its starting position, which is also the position at which the spring 326 is maximally extended and where tension on the spring is greatest.

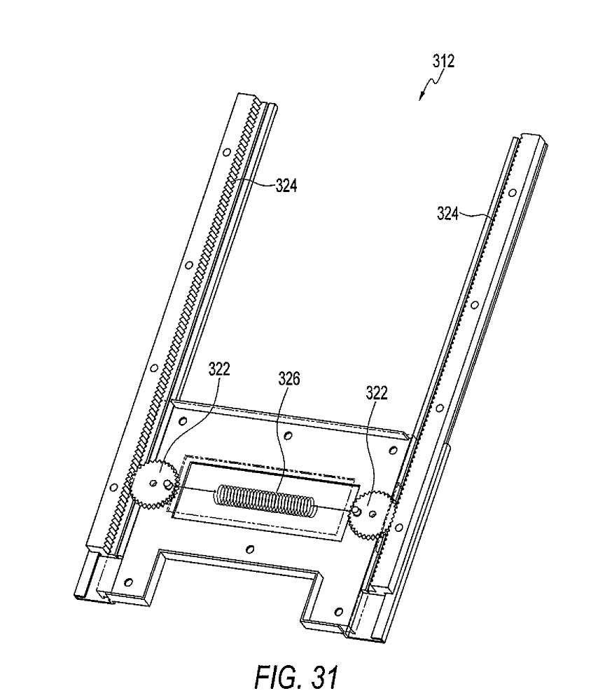

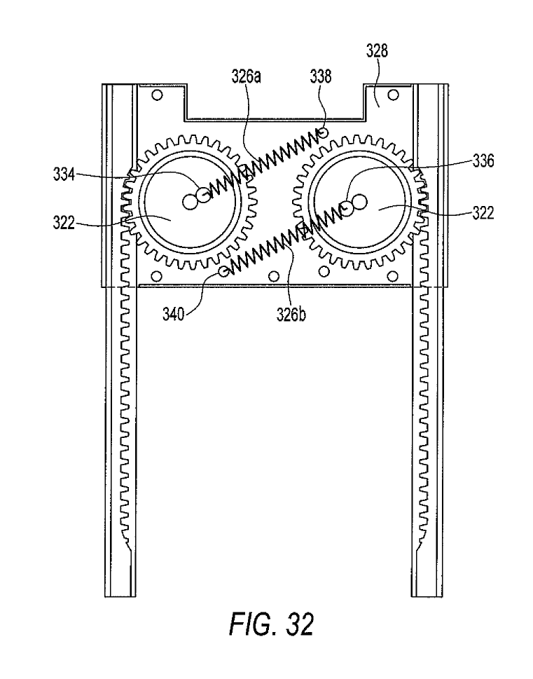

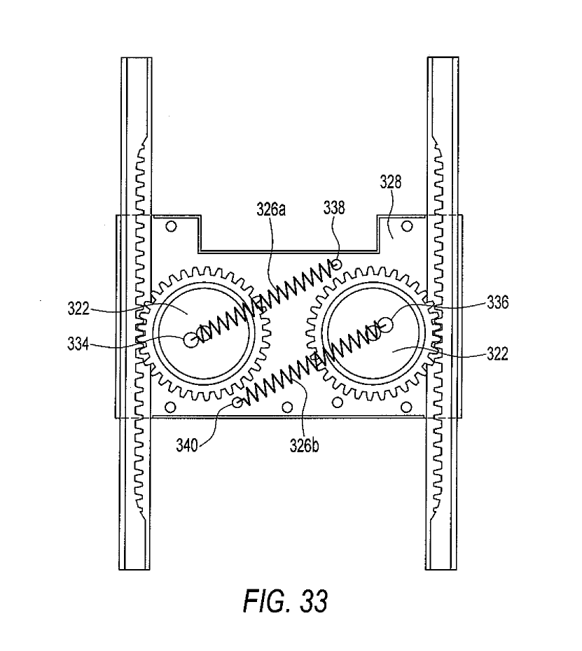

Thus, extension of the spring 326 requires increasing amounts of force until the gears 322 rotate 180°. If the operator continues to exert force sufficient to rotate the gears 322 past 180°, the spring 322 forces are such that the gears are urged to rotate for an additional 180° for a full rotation, at which point, the sliding assembly 312 is in its fully open position. In this manner, the sliding assembly 312 provides a partial assist in the opening of the sliding assembly into its fully open position. Reversal of the movement similarly provides a partial assist of the sliding assembly 312 back into its fully closed position.

Where it is the case that a particular application calls for a relatively larger range of motion along the guide rails 314, 316, larger gears 322 may be used. As gear size increases, however, the space available between the gears 322 to include the spring 326 is diminished. Accordingly, as illustrated in FIGS. 31-33, to provide the same amount of torsional forces, one alternative includes providing more than one spring 326, where the springs are coupled to one of the gears 322 as well as to the bottom housing 328.

More particularly, each spring 326a, 326b is coupled to one of the gears 322 via pins 334, 336 that are eccentrically mounted with respect to a rotational axis of the gears. Where a line may be drawn that represents a common diameter for both gears 322, the first pin 334 is disposed at least slightly above the common diameter whereas a second pin 336 is disposed at least slightly below the common diameter. Accordingly, a first anchor 338 for connecting the first spring 326a to the bottom housing 328 is disposed at a lower end of the bottom housing, and the first spring is coupled to the first anchor and the second pin 336. Similarly, a second anchor 340 for connecting the second spring 326b to the bottom housing 328 is disposed at an upper end of the bottom housing, and the second spring is coupled to the second anchor and the first pin 334.

Thus, as slider body 318 moves relative to the guide rails 314, 316, the gears 322 begin to rotate together, but in opposite directions with respect to one another. After each gear 322 rotates approximately 180°, the each spring 326a, 326b will be extended at a maximum load. While maximum loads may vary to suit individual applications by varying spring size, configuration and number, one preferred maximum load is approximately 3N. When the springs 326a, 326b are under maximum load, they are unstable, and once pushed slightly past 180°, the springs will bias the gears 322 to continue one full 360° rotation. As the gears 322 rotate, the slider body 318 and guide rails 314, 316 continue to slidably move relative to one another until the gears have rotated a full 360°, where one full rotation corresponds to a range of vertical motion between the slider body and the guide rails, at which time the sliding assembly 312 is in its fully open position.

Reversal of movement proceeds similarly, with the user exerting upward force such that the slider body 318 is moved slidably with respect to the guide rails 314, 316 toward the fully closed position. The gears 322 begin to rotate together in reverse directions compared to directions traveled in sliding toward the fully open position. After each gear 322 rotates just past approximately 180°, the springs 326a, 326b will urge the sliding assembly 312 into the full closed position. In this way, the biasing assembly 320 of the sliding assembly 312 provides a partial assist in the sliding movement of the slider body 318 and guide rails 314, 316 into each of the fully open and fully closed positions.

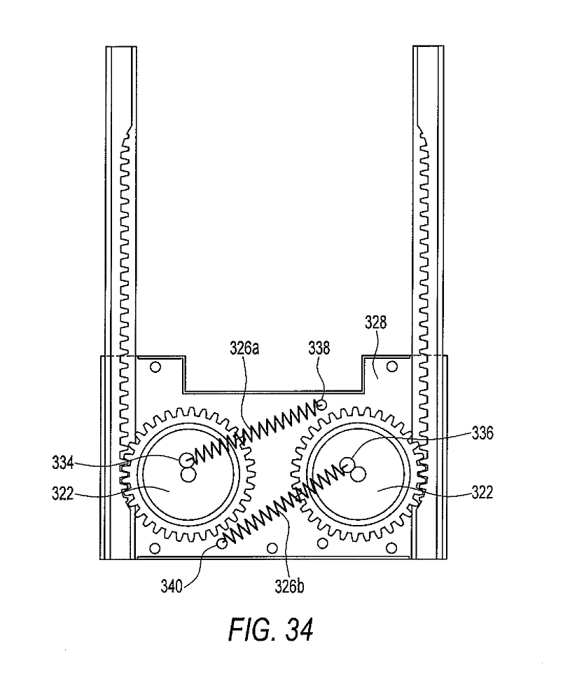

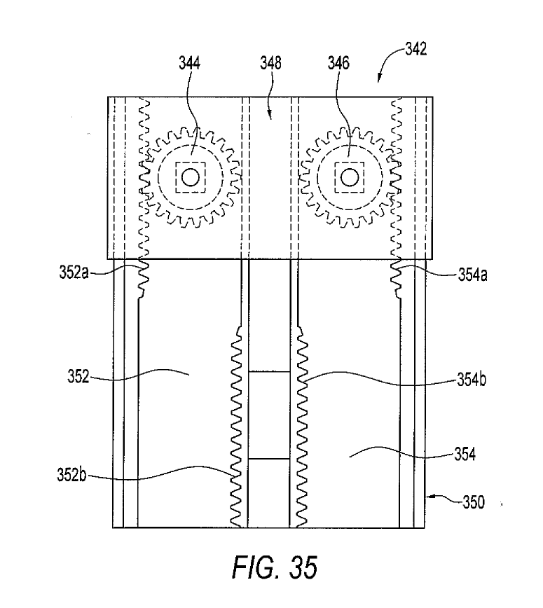

Still another embodiment of a preferred sliding assembly 342 is illustrated in FIGS. 34-35. The sliding assembly 342 according to this embodiment has a biasing assembly that includes a pair of gears 344, 346 coupled to a slider body 348 that is configured to engage and move slidably with a guide body 350 that includes a pair of guide channels 352, 354 disposed generally along a length of the guide body, where the guide channels are configured to receive the gears 344, 346 therein and guide the gears along a length of the guide body.

The guide channels 352, 354 each preferably include a pair of outer and inner gear tracks 352a, 352b, 354a, 354b. In the preferred sliding assembly 342, the outer gear tracks 352a, 354a are disposed near a top end of the guide body 350, and extend a predetermined distance along a length of the guide body, while the inner gear tracks 352b, 354b are disposed near a bottom end of the guide body and extending a predetermined distance along a length of the guide body. However, the invention contemplates that the relative top and bottom positions of the inner and outer gear tracks 352a, 352b, 354a, 354b may be reversed without departing from the preferred operation of the sliding assembly 342. Respective lengths of the outer gear tracks 352a, 354a and inner gear tracks 352b, 354b are preferably such that where the outer gear tracks terminate toward a center of a length of the guide body 350, the inner gear tracks begin extending from near a the center of the length of the guide body toward the bottom of the guide body, without lengthwise overlap of the inner and outer gear tracks.

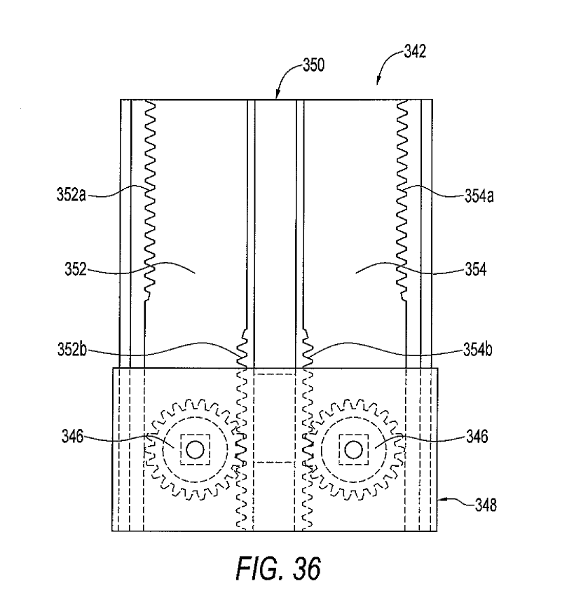

Clock springs (not shown) are preferably provided to couple the gears 344, 346 to the slider body 348, such that the clock springs are put under maximum tension at generally a middle portion of the guide body 350. More particularly, starting in the fully closed position (FIG. 35), as the gears 344, 346 rotate in the outer gear tracks 352a, 354a so as to move the slider body 348 downwardly with respect to the guide body 350, the clock springs are put under maximum tension at a position where the outer gear tracks terminate. Once the user pushes past this position, and the gears 344, 346 engage the inner gear tracks 352b, 354b, the clock springs begin to recoil, thereby urging the gears to rotate into the fully open position (FIG. 36). Similarly, to return the sliding assembly 342 to the fully closed position, the user urges the gears 344, 346 to rotate such that the slider body 348 moves upwardly with respect to the guide body 350, and the clock springs are put under maximum tension at a position where the inner gear tracks 352b, 354b terminate. Pushing past this point, the clock springs will begin to recoil as the gears continue to rotate in the outer gear tracks 352a, 354 in the direction of the fully closed position.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A self-contained sliding assembly for use with a sliding handset of the type having a keyboard part and a display part that are configured to slidably engage one another into fully open and fully closed positions, said assembly comprising:
at least one elongated guide rail;
a housing configured to engage said at least one guide rail and to move slidably along a length thereof; and
a biasing assembly for biasing relative sliding movement of said guide rail and said housing, said biasing assembly configured to include open and closed stop positions and a maximum load position at a predetermined point between said open and closed stop positions.

2. The sliding assembly of claim 1 further comprising left and right guide rails configured to be generally parallel to one another and to slidably engage corresponding left and right ends of said housing.

3. The sliding assembly of claim 2, said biasing assembly further comprising at least one spring configured to bias said sliding assembly into said open position at a first position relative said maximum load position and into said closed position at a second position relative said maximum load position.

4. The sliding assembly of claim 2, said biasing assembly further comprising at least one U-shaped spring and a linking arm, where said linking arm is coupled at a first end to a joint disposed between said guide rails and at a second end to said housing, and coupled to an end of said U-shaped spring at a third position disposed intermediate said first and second ends.

5. The sliding assembly of claim 4, said housing further comprising an elongated slot in which said second end of said linking arm slides, wherein a left end defines said open and closed positions and a right end defines said maximum load position.

6. The sliding assembly of claim 4, said biasing assembly further comprising two U-shaped springs configured and arranged to be concentric with one another.

7. The sliding assembly of claim 2, said biasing assembly including an elongated spring disposed in each of said guide rails, each of said elongated spring having a peak position defining said maximum load position.

8. The sliding assembly of claim 2, said guide rails further comprising an elongated guide track having a peak at generally a mid-point position thereof.

9. The sliding assembly of claim 8 wherein said elongated guide track is recessed within said guide track.

10. The sliding assembly of claim 8, said biasing assembly further comprising a leaf spring disposed between said guide rails and being configured to exert force outwardly from either end.

11. The sliding assembly of claim 8, said biasing assembly further comprising a roller wheel coupled to either end of a leaf spring and configured to operably engage one of said elongated tracks.

12. The sliding assembly of claim 2, each of said guide rails further comprising elongated gear tracks disposed along a length thereof.

13. The sliding assembly of claim 12, said biasing assembly further comprising at least one spring and first and second gears configured to engage a respective one of said elongated gear tracks.

14. The sliding assembly of claim 13, wherein said at least one spring comprises a helical spring coupled at each end to one of said gears and biased to prevent rotation of said gears.

15. The sliding assembly of claim 13 further comprising a first spring coupled to said first gear at one end and to said housing at an opposite end, and a second spring coupled to said second gear at one end and to said housing at an opposite end.

16. A self-contained sliding assembly for use with a sliding handset of the type having a keyboard part and a display part that are configured to slidably engage one another into fully open and fully closed positions, said assembly comprising:
guide means having a top end and a bottom end and being configured to provide a generally linear sliding path;
housing means configured to engage said guiding means and slide along at least a partial length thereof; and
biasing means having a maximum load point for alternatively biasing said housing means toward said top end and said bottom end of said guide means.

17. The sliding assembly of claim 16 wherein said guide means comprises two elongated guide rails.

18. The sliding assembly of claim 17 wherein said guide means further comprises a generally planar joint extending between said elongated guide rails.

19. The sliding assembly of claim 17 wherein said housing means comprises a housing body correspondingly configured to engage said two elongated guide rails and said planar joint, and to slide relative said guide rails and said planar joint.

20. The sliding assembly of claim 17 wherein said biasing means comprises at least one spring operably coupled to said guide means and configured to have maximum displacement at said maximum load point of said biasing means.

21. A self-contained sliding assembly for use with a sliding handset of the type having a keyboard part and a display part that are configured to slidably engage one another into fully open and fully closed positions, said assembly comprising:
first and second guide rails having a generally planar joint disposed therebetween;
a housing correspondingly configured to slidably engage said first and second guide rails and said joint, said housing having a generally horizontal elongated slot disposed through a surface of said housing that is configured to be parallel to said joint;
at least one U-shaped spring having first and second ends, said second end being coupled to said joint;
a linking arm having upper and lower ends, said upper end coupled to said elongated slot of said housing and said lower end coupled to said joint, and said linking arm being configured to be coupled to said first end of said at least one U-shaped spring at a point intermediate said upper and lower ends of said linking arm; and
wherein a length of said elongated slot defines a range of relative sliding movement between said guide rails and said housing.
